(19) United States
(12) Patent Application Publication
(10) Pub. No.: US 2026/0320849 A1
(43) Pub. Date: Oct. 15, 2026

(54) GENERATING CUSTOMIZED CONTEXTUAL DIGITAL IMAGE EDIT RECOMMENDATIONS

(71) Applicant: Adobe Inc., San Jose, CA (US)

(72) Inventors: Subham Gupta, Roorkee (IN); Arnab Sil, Khalisani (IN); Anuradha ., Bengaluru (IN)

(21) Appl. No.: 19/174,483

(22) Filed: Apr. 9, 2025

(51) Int. Cl. G06T 11/00; G06T 5/77; G06V 10/42; G06V 10/70; G06V 10/764; G06V 10/77; G06V 10/94; G06V 40/10

(52) U.S. Cl. CPC G06T 11/00; G06T 5/77; G06V 10/42; G06V 10/764; G06V 10/768; G06V 10/7715; G06V 10/95; G06V 40/10; G06T 2207/30196; G06V 2201/10

(57) ABSTRACT

The present disclosure is directed toward systems, methods, and non-transitory computer readable media that provide customized, context-specific edit recommendations for digital images. For example, the disclosed systems utilize a classification mode to determine a recommendation classification for a digital image by identifying distinguishable features displayed in the digital image. Furthermore, in one or more embodiments, the disclosed systems determine context-aware image features for the digital image that correspond to the recommendation classification. In certain cases, the disclosed systems utilize an edit recommendation model to generate context-specific modification recommendations for the digital image based on the context-aware image features. In some embodiments, the disclosed systems provide the context-specific modification recommendations to a client device, together with the digital image.

Advancements in computing devices and digital content design systems have led to innovative developments in computer image design and design software. For example, certain digital content design applications provide interfaces for user devices to interact with the content of digital images to create a variety of visual designs. In some cases, existing workflows of digital content design applications provide interfaces for selecting, adding, removing, or adjusting the content of digital images. For example, exiting digital design applications provide options within a graphical user interface to interact with specific regions of a digital image based on user selections. However, despite these advancements, existing image editing systems have a number of shortcomings with regard to efficacy and operational efficiency when generating customized, contextual edit recommendations for digital images.

### SUMMARY

One or more embodiments provide benefits and/or solve one or more of the foregoing or other problems in the art with systems, methods, and non-transitory computer readable storage media that provide customized, contextual edit recommendations for digital images based on the content and context of the digital images. For example, the disclosed systems utilize a classification model to determine a recommendation classification for a digital image based on the content type and context of the digital image. In some cases, the classification model identifies distinguishable features displayed in the digital image to determine the recommendation classification. Furthermore, in one or more embodiments, the disclosed systems determine context-aware image features for the digital image based on the recommendation classification. Utilizing the recommendation classification and the context-aware image features, embodiments of the disclosed systems utilize an edit recommendation model to generate context-specific modification recommendations for the digital image. Moreover, embodiments of the disclosed systems personalize the context-specific modification recommendations for the user account by incorporating user-specific attributes. Additionally, embodiments of the disclosed systems determine a predicted share destination for the digital image and generate a customized caption with a semantic structure based on the predicted share destination. In some cases, the disclosed systems provide the context-specific modification recommendations for display on a client device, together with the digital image.

### BRIEF DESCRIPTION OF THE DRAWINGS

This disclosure will describe one or more example embodiments of the systems and methods with additional specificity and detail by referencing the accompanying figures. The following paragraphs briefly describe those figures, in which:

FIG. 1 illustrates a schematic diagram of an example environment of a context-aware image refinement system in accordance with one or more embodiments;

FIG. 2 illustrates an example overview of the context-aware image refinement system generating context-specific modification recommendations for a digital image in accordance with one or more embodiments;

FIG. 3 illustrates an example of the context-aware image refinement system generating custom recommendations for a digital image based on a person-specific classification type in accordance with one or more embodiments;

FIG. 4 illustrates an example of the context-aware image refinement system generating custom recommendations for a digital image based on a subject-specific classification type in accordance with one or more embodiments;

FIG. 5 illustrates an example of the context-aware image refinement system generating custom recommendations for a digital image based on a global classification type in accordance with one or more embodiments;

FIG. 6 illustrates an example of the context-aware image refinement system generating a custom recommendation for a digital image from a context-specific modification request and/or a modification request in accordance with one or more embodiments;

FIG. 7 illustrates an example of the context-aware image refinement system generating a share recommendation for a digital image in accordance with one or more embodiments;

FIGS. 8A-8D illustrate an example of the context-aware image refinement system providing custom recommendations for display on a graphical user interface in accordance with one or more embodiments;

FIG. 9 illustrates a diagram of an example architecture of the context-aware image refinement system in accordance with one or more embodiments;

FIG. 10 illustrates a flowchart of a series of acts for generating context-specific recommendations and providing the context-specific modification recommendations to a client device in accordance with one or more embodiments; and

FIG. 11 illustrates a block diagram of an example computing device in accordance with one or more embodiments.

### DETAILED DESCRIPTION

This disclosure describes one or more embodiments of a context-aware image refinement system that provides customized, contextual edit recommendations for digital images. For example, the disclosed systems utilize a classification model to determine a recommendation classification for a digital image by identifying distinguishable features (e.g., people, objects, theme, context) associated with content displayed in the digital image. Furthermore, in one or more embodiments, the disclosed systems determine context-aware image features (e.g., edit presets, edit attributes, image content) for the digital image that correspond to the recommendation classification. In certain cases, the disclosed systems utilize an edit recommendation model to generate context-specific modification recommendations for the digital image based on the context-aware image features. Moreover, embodiments of the disclosed systems personalize the context-specific modification recommendations for the user account by incorporating user-specific attributes. Additionally, embodiments of the disclosed systems determine a predicted share destination for the digital image and generate a customized caption with a semantic structure based on the predicted share destination. In some embodiments, the disclosed systems provide the context-specific modification recommendations to a client device, together with the digital image.

More specifically, in one or more embodiments, the context-aware image refinement system utilizes a classification model to determine a recommendation classification for digital images. Based on the recommendation classification, the context-aware image refinement system generates context-specific modification recommendations for the digital images. For example, the context-aware image refinement system 106 determines the recommendation classification for the digital images by identifying distinguishable features displayed in the digital images. Utilizing the distinguishable features, the context-aware image refinement system determines a recommendation classification such as a person-specific classification type, a subject-specific classification type, and/or a global classification type.

Based on the recommendation classification, embodiments of the context-aware image refinement system determine corresponding context-aware image features. For example, for the person-specific classification type, the context-aware image refinement system generates the context-aware image features including a masked image depicting a person and portrait retouching attributes (such as image modifications to the physical appearance of an individual). In some embodiments, for the subject-specific classification type, the context-aware image refinement system generates the context-aware image features including subject-specific edit options that correspond to an identified subject in the digital image. In one or more embodiments, for the global classification type, the context-aware image refinement system generates the context-aware image features including a set of global presets (corresponding to global editing attributes) utilizing a global preset map.

Furthermore, embodiments of the context-aware image refinement system utilize an edit recommendation model to generate context-specific modification recommendations for the digital image based on the context-aware image features. For example, the context-aware image refinement system adaptively generates the context-specific modification recommendations customized to the characteristics of the digital image based on the recommendation classification and the context-aware image features. In one or more embodiments, the edit recommendation model utilizes a customization multimodal large language model to generate the context-specific modification recommendations. Based on the context-specific modification recommendations, embodiments of the context-aware image refinement system generate custom recommendations for display on a client device. In one or more embodiments, the context-aware image refinement system generates an explanation of how and why the digital image could benefit from the context-specific modification recommendations and/or the custom recommendations.

Moreover, embodiments of the context-aware image refinement system personalize the context-specific modification recommendations (and/or the custom recommendations). For example, the context-aware image refinement system extracts metadata for a user account associated with the digital image to personalize the context-specific modification recommendations for the user account. In some cases, the context-aware image refinement system personalizes the context-specific modification recommendations by incorporating labels and/or names for distinguishable features displayed in the digital image into the context-specific modification recommendations.

In some embodiments, the context-aware image refinement system enhances the context-specific modification recommendations by determining a predicted share destination for sharing the digital image by the user account. Based on the predicted share destination, the context-aware image refinement system generates a share recommendation for the digital image. In one or more embodiments, the share recommendation includes a customized caption with a semantic structure based on the share destination (e.g., with a particular tone, format, and style).

As mentioned, existing image editing systems have a number of technical shortcomings, particularly in terms of efficacy and operational efficiency when modifying digital images. For example, existing systems are ineffective when providing editing suggestions for digital images. For example, while some existing systems provide image editing suggestions, these systems fail provide accurate and effective recommendations adjusted to the specific context of the image, leading to operational inefficiencies in image editing workflows. For example, many existing systems generate generic, one-size-fits-all suggestions that fail to adapt to the unique characteristics of a digital image. As a result, many existing systems provide imprecise or irrelevant image editing suggestions that do not align with the visible characteristics of the digital image. To illustrate, some existing systems suggest sky editing modifications without considering differences between a bright daytime sky and a dark nighttime sky, resulting in irrelevant or redundant editing suggestions.

Relatedly, existing systems are operationally inefficient, requiring an excessive number of device interactions per edit. For example, many existing systems require user devices to navigate through multiple menus, confirm selections, and make repeated adjustments to achieve a desired effect. This fragmented editing approach of existing systems when providing editing suggestions, largely due to the cumbersome and overly complex navigation required by existing systems, results in excess device interactions. As an example, many systems require user devices to perform a series of device interactions to search for contextually appropriate image adjustments.

Furthermore, many existing systems struggle with inefficiencies on mobile devices, where limited screen space restricts tool accessibility and usability. For example, many existing systems attempt to compress complex editing tools into small displays, resulting in complicated menus and difficult-to-navigate controls. In some cases, existing systems provide a standardized subset of editing tools for mobile devices (e.g., a generic subset of possible editing tools), leading to restrictive or irrelevant editing suggestions that do not align with image content. Without providing contextual editing suggestions, existing systems often require mobile devices to navigate through multiple menus to make image adjustments, resulting in operational inefficiencies.

As suggested above, embodiments of the context-aware image refinement system overcome these and other disadvantages inherent in existing image editing systems. For example, the context-aware image refinement system provides advantages in efficacy over existing systems. Unlike existing systems that provide generic image editing suggestions unrelated to image context, the context-aware image refinement system provides custom recommendations based on both the content and context of digital images. For example, the context-aware image refinement system generates customized context-specific modification recommendations for diverse visual elements such as such as people, subjects, background, architecture, mountains, ground, water, and plants. To illustrate, embodiments of the context-aware image refinement system provide recommendations that preserve natural depth and contrast for an image featuring a night sky (to ensure details remain visible), while optimizing for warm tones and color balance for an image of a bright sunset sky.

Furthermore, embodiments of the context-aware image refinement system introduce a novel personalization model that personalizes the custom recommendations based on user-specific data. Unlike existing systems that apply generic editing suggestions to all user accounts, the context-aware image refinement system utilizes the personalization model to generate custom recommendations personalized based on user account metadata, subject names, and share history. For example, by analyzing detected objects (e.g., people, landmarks, objects) and predicting likely share destinations, the context-aware image refinement system dynamically adjusts the custom recommendations to incorporate personalization relevant to the detected content for the user account.

Moreover, the context-aware image refinement system improves operational efficiency over existing systems. By avoiding unwarranted editing suggestions, embodiments of the context-aware image refinement system optimize the features of the user interface, providing a concise and effective editing workflow. The streamlined workflow of the context-aware image refinement system is particularly beneficial for mobile devices, where limited screen space makes the menu navigation of some existing systems cumbersome. For example, instead of requiring user devices to search through complex menus, the context-aware image refinement system generates custom recommendations tailored to digital image context, thereby reducing device interactions and system complexity.

Beyond improving edit selection, the context-aware image refinement system increases operational efficiency by providing rationale-backed custom recommendations that specify how and why the digital images could benefit from the suggested modifications. For example, rather than simply providing custom recommendations without contextual cues, the context-aware image refinement system provides targeted explanations to provide context for the custom recommendations. By incorporating such explanations, the context-aware image refinement system streamlines the editing workflow, minimizes reliance on trial-and-error corrections, and improves the predictability of image edits.

Moreover, the context-aware image refinement system enhances operational efficiency by seamlessly integrating the image editing and image sharing into a unified workflow. Unlike existing systems that require separate user device interactions for image editing and image sharing, the context-aware image refinement system utilizes predictive modeling to autonomously identify predicted share destinations and generate platform-specific captions. By analyzing image content and historical sharing patterns, the context-aware image refinement system reduces user device interactions and accelerates the image-sharing process. Additionally, the context-aware image refinement system optimizes the customized captions to comply with platform-specific formatting requirements to generate customized captions that are accurately structured for sharing.

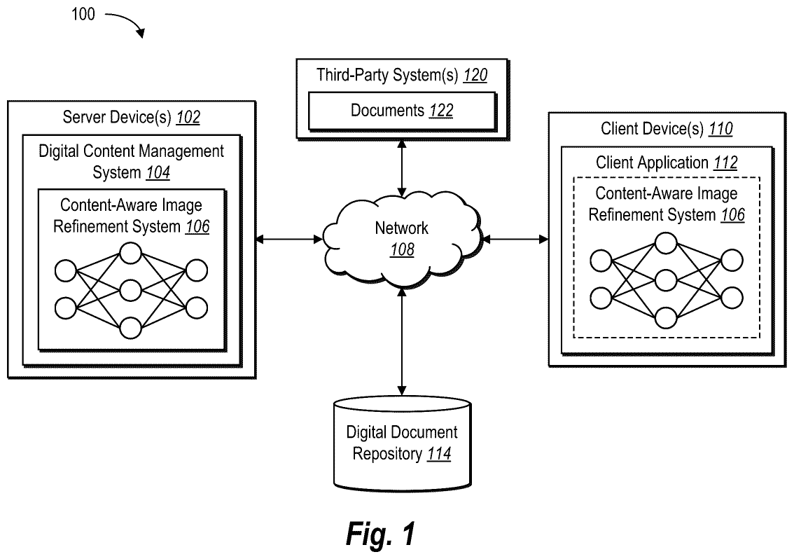

Additional detail regarding the context-aware image refinement system will now be provided with reference to the figures. For example, FIG. 1 illustrates a schematic diagram of an exemplary system environment (e.g., environment 100) in which a context-aware image refinement system 106 operates. As illustrated in FIG. 1, the environment 100 includes server device(s) 102, a network 108, client device(s) 110, digital document repository 114, and third-party system(s) 120.

Although the environment 100 of FIG. 1 is depicted as having a particular number of components, the environment 100 is capable of having any number of additional or alternative components (e.g., any number of servers, client devices, or other components) in communication with the context-aware image refinement system 106 via the network 108. Similarly, although FIG. 1 illustrates a particular arrangement of the server device(s) 102, the network 108, the client device(s) 110, the digital document repository 114, and the third-party system(s) 120, various additional arrangements are possible.

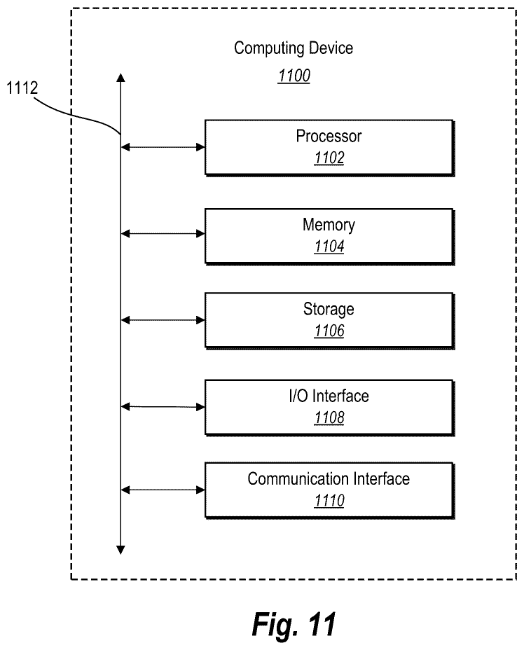

The server device(s) 102, the network 108, the client device(s) 110, the digital document repository 114, and the third-party system(s) 120 are communicatively coupled with each other either directly or indirectly (e.g., through the network 108 discussed in greater detail below in relation to FIG. 11). Moreover, the server device(s) 102 and the client device(s) 110 include one of a variety of computing devices (including one or more computing devices as discussed in greater detail with relation to FIG. 11).

As illustrated in FIG. 1, the environment 100 includes the server device(s) 102 and the digital content management system 104. The server device(s) 102 utilizes the digital content management system 104 to generate, track, store, process, receive, and transmit electronic data including digital images, image masks, context-aware image features, context-specific modification recommendations, and custom recommendations. For example, the server device(s) 102 receives or monitors interactions across the client device(s) 110. In some embodiments, the server device(s) 102 transmits content to the client device(s) 110 to cause the client device(s) 110 to display and execute content associated with generating customized contextual digital image edit recommendations. For example, the server device(s) 102 presents the digital images, image masks, context-aware image features, context-specific modification recommendations, and custom recommendations to client device(s) 110. The client device(s) 110 displays the digital images, image masks, context-aware image features, context-specific modification recommendations, and custom recommendations on the client device(s) 110 with the digital images, image masks, context-aware image features, context-specific modification recommendations, and custom recommendations, displayed and/or determined corresponding to system need (e.g., digital images, image masks, context-aware image features, context-specific modification recommendations, and custom recommendations for display and/or determination via the client application 112). The server device(s) 102 further accesses and utilizes the digital document repository 114 to store and retrieve information such as digital images, image masks, context-aware image features, context-specific modification recommendations, and custom recommendations, and/or other data.

Additionally, the server device(s) 102 includes all, or a portion of, the context-aware image refinement system 106. For example, the context-aware image refinement system 106 operates on the server device(s) 102 to access digital content (including digital images, image masks, context-aware image features, context-specific modification recommendations, and custom recommendations), determine digital content changes, execute digital content, and provide localization of content changes to the client device(s) 110 and/or finetune large language models. In some cases, the context-aware image refinement system 106 utilizes, locally on the server device(s) 102 or from another network location (e.g., the digital document repository 114), the context-aware image refinement system 106. In one or more embodiments, via the server device(s) 102, the context-aware image refinement system 106 generates, executes, and displays digital images, image masks, context-aware image features, context-specific modification recommendations, and custom recommendations based on the client device(s) 110 input. Example components of the context-aware image refinement system 106 will be described below with regard to FIG. 11.

Furthermore, as shown in FIG. 1, the illustrated system includes the client device(s) 110. In some embodiments, the client device(s) 110 include, but are not limited to, mobile devices (e.g., smartphones, tablets), laptop computers, desktop computers, or another type of computing devices, including those explained below in reference to FIG. 11. In certain cases, the client device(s) 110 includes all or part of the context-aware image refinement system 106. For example, the client device(s) 110 generates, obtains (e.g., downloads), or utilizes one or more aspects of the context-aware image refinement system 106 from the server device(s) 102. Indeed, in some implementations, as illustrated in FIG. 1, the context-aware image refinement system 106 is located in whole or in part on the client device(s) 110. For example, the context-aware image refinement system 106 includes a web hosting application that allows the client device(s) 110 to interact with the server device(s) 102. To illustrate, in one or more implementations, the client device(s) 110 accesses a web page supported and/or hosted by the server device(s) 102.

In one or more embodiments, the client device(s) 110 and the server device(s) 102 work together to implement the context-aware image refinement system 106. For example, in some embodiments, the server device(s) 102 train the large language models and provide the large language models to the client device(s) 110 for implementation. In some embodiments, the client device(s) 110 provides digital images and text prompts, the server device(s) 102 trains and/or implements the large language models to generate the customized contextual digital image edit recommendations, and the client device(s) 110 presents the customized contextual digital image edit recommendations. Furthermore, in some implementations, the client device(s) 110 assists in training and/or implementing the large language models to generate the customized contextual digital image edit recommendations.

Some embodiments of client device(s) 110 are operated by a user to perform a variety of functions via client application 112 such as the generation/modification of the digital images, image masks, context-aware image features, context-specific modification recommendations, and custom recommendations. The client device(s) 110 include one or more applications (e.g., the client application 112) that access, edit, modify, store, execute, and/or provide, for display, digital images, image masks, context-aware image features, context-specific modification recommendations, and custom recommendations. For example, in some embodiments, the client application 112 includes a software application installed on the client device(s) 110. In other cases, however, the client application 112 includes a web browser or other application that accesses a software application hosted on the server device(s) 102.

In one or more embodiments, the context-aware image refinement system 106 is implemented in whole, or in part, by the individual elements of the environment 100. Indeed, as shown in FIG. 1, the context-aware image refinement system 106 is implemented with regard to the server device(s) 102 and the client device(s) 110. In particular embodiments, the context-aware image refinement system 106 on the client device(s) 110 comprises a web application, a native application installed on the client device(s) 110 (e.g., a mobile application, a desktop application, a plug-in application, etc.), or a cloud-based application where part of the functionality is performed by the server device(s) 102.

In additional or alternative embodiments, the context-aware image refinement system 106 on the client device(s) 110 represents and/or provides the same or similar functionality as described herein in connection with the context-aware image refinement system 106 on the server device(s) 102. In some embodiments, the context-aware image refinement system 106 on the server device(s) 102 supports the context-aware image refinement system 106 on the client device(s) 110.

In some embodiments, the context-aware image refinement system 106 includes a web hosting application that allows the client device(s) 110 to interact with content and services hosted on the server device(s) 102. To illustrate, in one or more embodiments, the client device(s) 110 accesses a web page or computing application supported by the server device(s) 102. The client device(s) 110 provides input to the server device(s) 102 (e.g., user interactions). In response, the context-aware image refinement system 106 on the server device(s) 102 generates and/or determines digital images, image masks, context-aware image features, context-specific modification recommendations, and custom recommendations. The server device(s) 102 then provides the digital images, image masks, context-aware image features, context-specific modification recommendations, and custom recommendations to the client device(s) 110.

In some embodiments, the context-aware image refinement system 106 includes the third-party system(s) 120 and documents 122. To illustrate, in one or more embodiments, the context-aware image refinement system 106 interacts with content and services hosted on the third-party system(s) 120. To illustrate, in one or more embodiments, the context-aware image refinement system 106 accesses a web page or computing application supported by the third-party system(s) 120. The third-party system(s) 120 provide input to the context-aware image refinement system 106 and the documents 122 (e.g., digital images). In response, the context-aware image refinement system 106 generates/modifies digital content including digital images, image masks, context-aware image features, context-specific modification recommendations, and custom recommendations and/or interacts with the third-party system(s) 120 to generate/modify digital images, image masks, context-aware image features, context-specific modification recommendations, and custom recommendations. The context-aware image refinement system 106 then provides the digital content to the third-party system(s) 120.

In some embodiments, though not illustrated in FIG. 1, the environment 100 has a different arrangement of components and/or has a different number or set of components altogether. For example, in certain embodiments, the client device(s) 110 communicate directly with the server device(s) 102, bypassing the network 108. As another example, the environment 100 includes a third-party server comprising a content server and/or a data collection server.

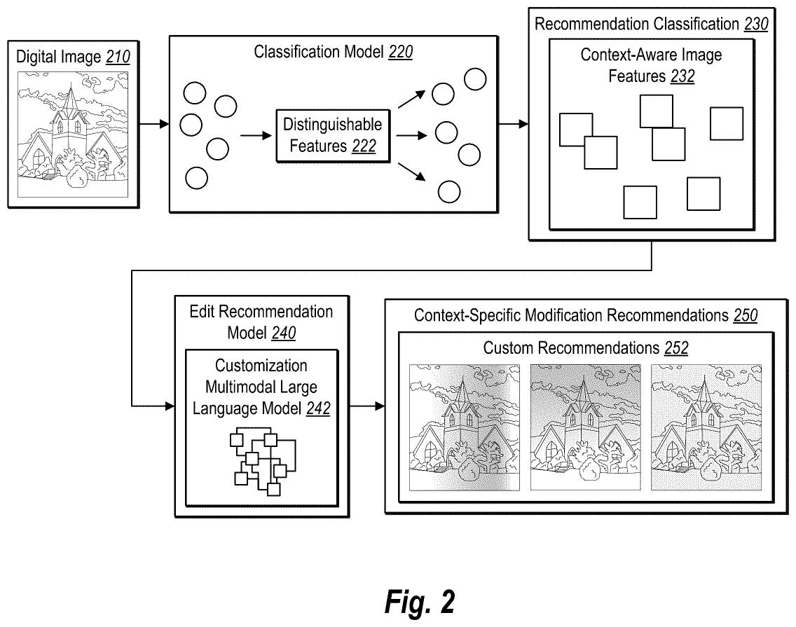

As previously mentioned, in one or more embodiments, the context-aware image refinement system 106 analyzes a digital image to generate customized contextual digital image edit recommendations based on distinguishable features displayed in the digital image. For instance, FIG. 2 illustrates an example overview of the context-aware image refinement system 106 generating context-specific modification recommendations for a digital image in accordance with one or more embodiments. Additional detail regarding the various acts of FIG. 2 is provided thereafter with reference to subsequent figures.

As shown in FIG. 2, the context-aware image refinement system 106 receives or accesses a digital image 210. For example, the digital image 210 includes a grid of pixels where each pixel encodes color and brightness values. In some cases, the digital image 210 depicts content such as persons, subjects, objects, architecture, landscapes, nature, and/or designs. In one or more implementations, the context-aware image refinement system 106 receives the digital image 210 via user input or through a client application. For example, the context-aware image refinement system 106 receives the digital image 210 captured using a camera, smartphone, screenshot, or digital software for use within an image editing or image sharing application.

In one or more embodiments, the context-aware image refinement system 106 utilizes a classification model 220 to analyze the digital image 210 and determine a recommendation classification 230 for the digital image 210. As used herein the recommendation classification 230 includes or refers to a categorization of a modification suggestion based on image content, image context, and/or modification suggestion type. In some cases, the recommendation classification 230 includes a modification suggestion type based on distinguishable features displayed in the digital image. For example, utilizing the distinguishable features of the digital image 210, the context-aware image refinement system determines a recommendation classification such as a person-specific classification type, a subject-specific classification type, and/or a global classification type.

In some cases, the classification model 220 utilizes one or more deep learning models to segment and classify the digital image 210. To elaborate, as used herein a deep learning model includes or refers to a machine learning model such as a convolutional neural network or vision transformer trained to perform computational tasks to process complex data representations. For example, a deep learning model includes a computer algorithm or a collection of computer algorithms trainable and/or tunable based on inputs to approximate unknown functions. In some cases, a deep learning model utilizes a transformer architecture, which includes mechanisms such as self-attention, to capture contextual relationships in the data. For example, a deep learning model includes a computer algorithm with branches, weights, or parameters that change based on training data to improve for a particular task. Thus, a deep learning model utilizes one or more learning techniques (e.g., supervised, unsupervised, or reinforcement learning) to improve in accuracy and/or effectiveness.

Similarly, as used herein, a neural network refers to a machine learning model of interconnected nodes (or neurons) organized into layers. A neural network includes parameters or weights between neurons that are adjusted during training to minimize the error (or measure of loss) in generating predictions. A deep learning model includes a neural network, a large language model, or a multimodal large language model that analyzes various types of structured and unstructured data, including language, images, and signals, to generate a predicted output. For example, a deep learning model includes a neural network that performs text generation, image recognition, reinforcement learning, and generative modeling.

As illustrated in FIG. 2, embodiments of the context-aware image refinement system 106 utilize the classification model 220 to analyze the digital image to identify distinguishable features 222 (e.g., key elements) displayed in the digital image 210. Utilizing the distinguishable features 222, embodiments of the context-aware image refinement system 106 determine the recommendation classification 230. As used herein, the distinguishable features 222 include or refer to identifiable components of the digital image 210 such as people, places, objects, contextual elements, architectural structures, and/or natural scenery. In some cases, the context-aware image refinement system 106 utilizes the classification model 220 to identify the distinguishable features 222 by performing object recognition on the digital image 210.

Furthermore, embodiments of the context-aware image refinement system 106 utilize the classification model 220 to determine the recommendation classification 230. In some cases, the context-aware image refinement system 106 analyzes the distinguishable features 222 of the digital image 210 to determine the recommendation classification 230 such as a person-specific classification type, a subject-specific classification type, and/or a global classification type. To illustrate, in some cases, the context-aware image refinement system 106 determines a person-specific classification type for the recommendation classification 230 based on identifying one or more individuals as prominent elements (e.g., distinguishable features) in the digital image 210. In some cases, the context-aware image refinement system 106 determines a subject-specific classification type for the recommendation classification 230 based on identifying one or more distinct objects (or prominent subjects) in the digital image 210. In some embodiments, the context-aware image refinement system 106 determines a global classification type for the recommendation classification 230 associated with global modifications to the digital image 210.

Based on the recommendation classification 230, embodiments of the context-aware image refinement system 106 determine one or more of the context-aware image features 232. As used herein, the context-aware image features 232 include or refer to image features utilized to generate the context-specific modification recommendations 250 based on the recommendation classification 230. In some cases, the context-aware image refinement system 106 extracts visual and/or semantic attributes from the digital image 210 for the context-aware image features 232 based on the recommendation classification 230. In some cases, the context-aware image refinement system 106 determines the context-aware image features 232 including adaptive presets or image modification attributes that corresponding to the recommendation classification 230.

For example, for the person-specific classification type, the context-aware image refinement system 106 generates the context-aware image features 232 including a masked image (depicting a person) and portrait retouching attributes (such as image modifications to the physical appearance of an individual). In some embodiments, for the subject-specific classification type, the context-aware image refinement system 106 generates the context-aware image features 232 including subject-specific edit options including subject-specific edit options that correspond to an identified subject in the digital image. In one or more embodiments, for the global classification type, the context-aware image refinement system 106 generates the context-aware image features 232 including a set of global presets (corresponding to global editing attributes) utilizing a global preset map.

As further illustrated in FIG. 2, embodiments of the context-aware image refinement system 106 utilize an edit recommendation model 240 to generate context-specific modification recommendations 250 for the digital image 210. As used herein, the context-specific modification recommendations 250 include or refer to adaptively generated context-specific modification recommendations tailored to the characteristics of the digital image 210 based on the recommendation classification 230 and the context-aware image features 232. For example, the context-specific modification recommendations 250 include editing suggestions that are adaptively generated based on the content and context of the digital image 210. In some cases, the context-specific modification recommendations 250 include modification recommendations based on image content (such as persons, objects, architecture, landscapes), image context (such as indoor, outdoor, daytime, nighttime, weather), and image composition (such as portraits, landscapes, framing).

In one or more embodiments, the edit recommendation model 240 utilizes a customization multimodal large language model 242 to generate the context-specific modification recommendations 250. For example, the edit recommendation model 240 generates a context-specific recommendation prompt including the context-aware image features 232 and an instruction to generate the context-specific modification recommendations 250 for the digital image 210 based on the context-aware image features 232. In some cases, the edit recommendation model 240 generates, utilizing the customization multimodal large language model 242 from the context-specific recommendation prompt, the context-specific modification recommendations 250 for the digital image 210.

As used herein, a customization multimodal large language model 242 (or MLLM) includes or refers to a large language model (e.g., a deep learning model) that incorporates visual and textual information for multimodal reasoning to generate answers to questions from a natural language query. The customization multimodal large language model 242 includes a neural network trained on both textual and visual data, allowing the model to analyze image-based inputs, such as the digital image 210 alongside textual queries. In some cases, the customization multimodal large language model 242 includes an architecture that processes document images, analyzing visual layouts to determine contextual digital image edit recommendations. Similar to large language models, the customization multimodal large language model 242 utilizes self-attention mechanisms but extends them to cross-modal attention, enabling the fusion of language and image representations for tasks such as determining the context-specific modification recommendations 250 for the digital image 210.

Along these lines, the machine learning models (e.g., the customization multimodal large language model 242, the classification model 220) used herein are trainable and/or fine-tunable to perform diverse natural language processing tasks and multimodal analysis tasks. For example, the machine learning models consist of layers of interconnected artificial neurons organized in encoder and decoder blocks, which learn complex language patterns to generate textual content or align textual queries with visual data. In some cases, the machine learning models used herein include models or architectures that utilize self-attention and cross-attention mechanisms for natural language understanding and multimodal content analysis. In certain embodiments, a large language model or multimodal large language model refers to an artificial neural network trained by the context-aware image refinement system 106 to generate context-specific modification recommendations 250 based on the recommendation classification 230 and the context-aware image features 232.

As illustrated in FIG. 2, based on the context-specific modification recommendations 250, embodiments of the context-aware image refinement system 106 generate custom recommendations 252. As used herein, the custom recommendations 252 include or refer to modification recommendations tailored for display on a client device. For example, the custom recommendations 252 include edit suggestions that correspond the context-specific modification recommendations 250 optimized for presentation on the client device. In one or more embodiments, the context-aware image refinement system 106 utilizes the context-specific modification recommendations 250 to select from a collection of context-specific selection presets to generate the custom recommendations 252 for display on a client device. In some cases, the context-aware image refinement system 106 generates an explanation of how and why the digital image could benefit from the context-specific modification recommendations 250 for the custom recommendations 252.

Moreover, embodiments of the context-aware image refinement system 106 personalize the context-specific modification recommendations 250. For example, the context-aware image refinement system 106 extracts metadata for a user account associated with the digital image to personalize the context-specific modification recommendations 250 (and/or the custom recommendations 252) for the user account. In some cases, the context-aware image refinement system 106 incorporates labels/names for distinguishable features displayed in the digital image 210 into the context-specific modification recommendations 250. In some embodiments, the context-aware image refinement system 106 personalizes the context-specific modification recommendations 250 by determining a predicted share destination for sharing the digital image 210 by the user account and generating a customized caption for the predicted share destination.

In certain embodiments, the context-aware image refinement system 106 provides one or more customized contextual digital image edit recommendations for display on a client device. In certain cases, the context-aware image refinement system 106 provides the context-specific modification recommendations 250 to the client device together with the digital image 210. In certain cases, the context-aware image refinement system 106 provides the custom recommendations 252 to the client device together with the digital image 210.

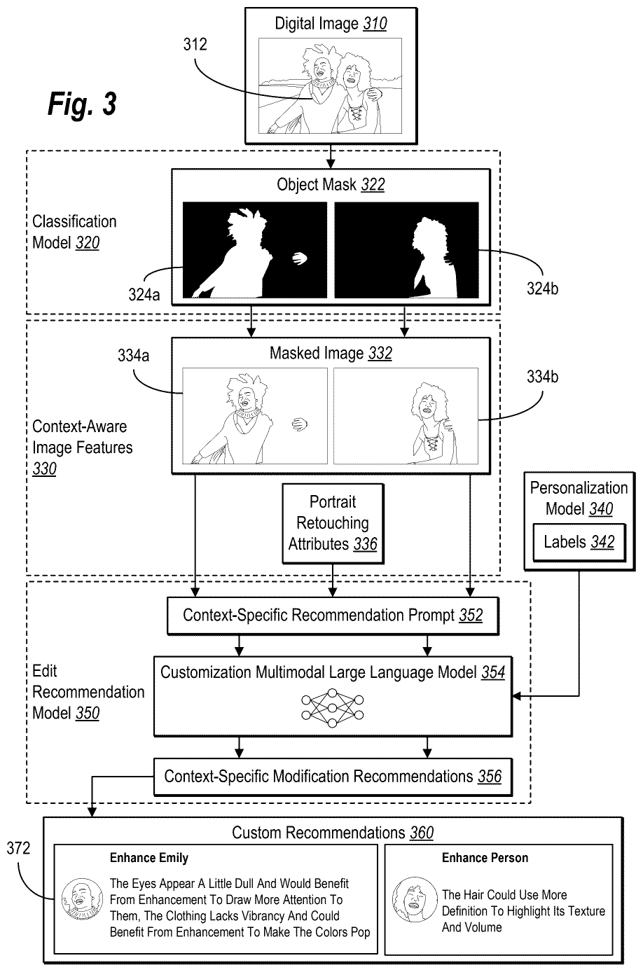

As mentioned, in one or more embodiments, the context-aware image refinement system 106 generates custom recommendations for a digital image based on a recommendation classification such as a person-specific classification type, a subject-specific classification type, and/or a global classification type. For example, FIG. 3 illustrates the context-aware image refinement system 106 generating custom recommendations for a digital image based on a person-specific classification type in accordance with one or more embodiments.

As shown in FIG. 3, in certain embodiments, the context-aware image refinement system 106 utilizes a classification model 320 to determine a person-specific classification type for the recommendation classification based on identifying one or more persons as prominent elements (e.g., distinguishable features) displayed in a digital image 310. In certain embodiments, the classification model 320 utilizes deep learning-based object recognition (e.g., convolutional neural networks or vision transformers) to analyze facial landmarks, clothing, and body proportions to distinguish persons (e.g., individuals) from other objects in the digital image 310. In one or more embodiments, the context-aware image refinement system 106 utilizes the classification model 320 to evaluate whether a detected person is a dominant subject in the digital image 310 utilizing a size, a position, a focus, and/or a depth of field corresponding to the person. In some cases, the context-aware image refinement system 106 determines a detected person is a dominant subject and classifies the image as a person-specific classification type.

In certain embodiments, the context-aware image refinement system 106 utilizes the classification model 320 to generate object mask(s) 322 to determine the recommendation classification. In one or more embodiments, the context-aware image refinement system 106 generates one or more of the object mask(s) 322 corresponding to persons identified in the digital image 310. In some cases, the context-aware image refinement system 106 generates the object mask(s) 322 as binary masks that separate the selected persons from the other content of the digital image 310. In some cases, the context-aware image refinement system 106 utilizes a segmentation model to generate one or more binary pixel-wise masks to differentiate the selected persons. To illustrate, as shown in FIG. 3, the context-aware image refinement system 106 generates the object mask 324a representing a first person in the digital image 310 and the object mask 324b representing a second person in the digital image 310.

As described above, in one or more embodiments, the context-aware image refinement system 106 determines context-aware image features 330 corresponding to the recommendation classification for the digital image 310. In some cases, for a recommendation classification corresponding to the person-specific classification type, the context-aware image refinement system 106 generates the context-aware image features 330 including masked image(s) 332 generated from the digital image 310 using the object mask(s) 322. In some cases, for a recommendation classification corresponding to a person-specific classification type, the context-aware image refinement system 106 generates the context-aware image features 330 include portrait retouching attributes 336.

For example, the context-aware image refinement system 106 generates the masked image(s) 332 utilizing the object mask(s) 322. To illustrate, the context-aware image refinement system 106 applies the object mask 324a to generate masked image 334a and applies the object mask 324b to generate masked image 334b. In some cases, the context-aware image refinement system 106 applies the object mask(s) 322 by setting non-person pixels to transparent or removing non-person pixels from the digital image 310 to generate the masked image(s) 332. As shown, embodiments of the context-aware image refinement system 106 generate one or more of the masked image(s) 332 corresponding to the prominent persons detected in the digital image 310.

As further shown in FIG. 3, embodiments of the context-aware image refinement system 106 determine the portrait retouching attributes 336 as one or more of the context-aware image features 330. In certain embodiments, the context-aware image refinement system 106 determines the portrait retouching attributes 336 by selecting from a collection of preset attributes for enhancing/refining the physical appearance of persons in the digital image 310. In one or more embodiments, the context-aware image refinement system 106 determines the portrait retouching attributes 336 as attributes corresponding to person-specific modifications of digital content. For example, the context-aware image refinement system 106 determines the portrait retouching attributes 336 including parameters for facial adjustments (e.g., skin smoothing, skin tone correction, shine reduction), feature enhancements (e.g., eye brightening, hair definition, eyelash enhancement), or lighting adjustments (e.g., face highlighting, eye light reflection, facial contrast).

In one or more embodiments, the context-aware image refinement system 106 utilizes an edit recommendation model 350 to generate one or more of the context-specific modification recommendations 356 for the digital image 310. For example, the context-aware image refinement system 106 generates the context-specific recommendation prompt 352 from the context-aware image features 330 (e.g., the masked image(s) 332 and the portrait retouching attributes 336). In one or more embodiments, the context-aware image refinement system 106 generates the context-specific recommendation prompt 352 including the masked image(s) 332, the portrait retouching attributes 336, and an instruction to generate the context-specific modification recommendations 356 that includes a person-specific modification to the digital image 310.

To illustrate, as shown in FIG. 3, the context-aware image refinement system 106 generates the context-specific recommendation prompt 352 including the masked image 334a, the portrait retouching attributes 336, and an instruction to generate the context-specific modification recommendations 356 that includes a person-specific modification to the person 312 in the digital image 310. Moreover, based on the context-specific recommendation prompt 352, embodiments of the context-aware image refinement system 106 utilize a customization multimodal large language model 354 to generate the context-specific modification recommendations 356. For example, the edit recommendation model 350 prompts the customization multimodal large language model 354 (utilizing the context-specific recommendation prompt 352) to generate the context-specific modification recommendations 356.

As further illustrated, in certain embodiments, the context-aware image refinement system 106 utilizes a personalization model 340 to personalize the context-specific modification recommendations 356 and/or the custom recommendations 360. For example, the context-aware image refinement system 106 extracts metadata associated with a user account to determine labels 342 (e.g., names, descriptions) corresponding to persons in the digital image 310. In some cases, the context-aware image refinement system 106 identifies a person in the digital image 310, maps the person to stored profile data, and generates the labels 342 corresponding to the identified persons. To illustrate, as shown in FIG. 3, the context-aware image refinement system 106 utilizes the personalization model 340 to personalize the context-specific modification recommendations 356 for the masked image 334a by determining a name for the person 312 of the digital image 310 (as shown by the name “Emily” in custom recommendation 372).

In one or more embodiments, the context-aware image refinement system 106 generates the custom recommendations 360 for display on a client device. In some cases, the context-aware image refinement system 106 generates the custom recommendations 360 based on the context-specific modification recommendations 356. To illustrate, as shown in FIG. 3, the context-aware image refinement system 106 generates the custom recommendation 372 that includes a context-specific modification recommendation of a person-specific enhancement for the person 312. As also shown, the context-aware image refinement system 106 generates the custom recommendation 372 including an explanation detailing how and why the digital image 310 could benefit from the custom recommendation 372.

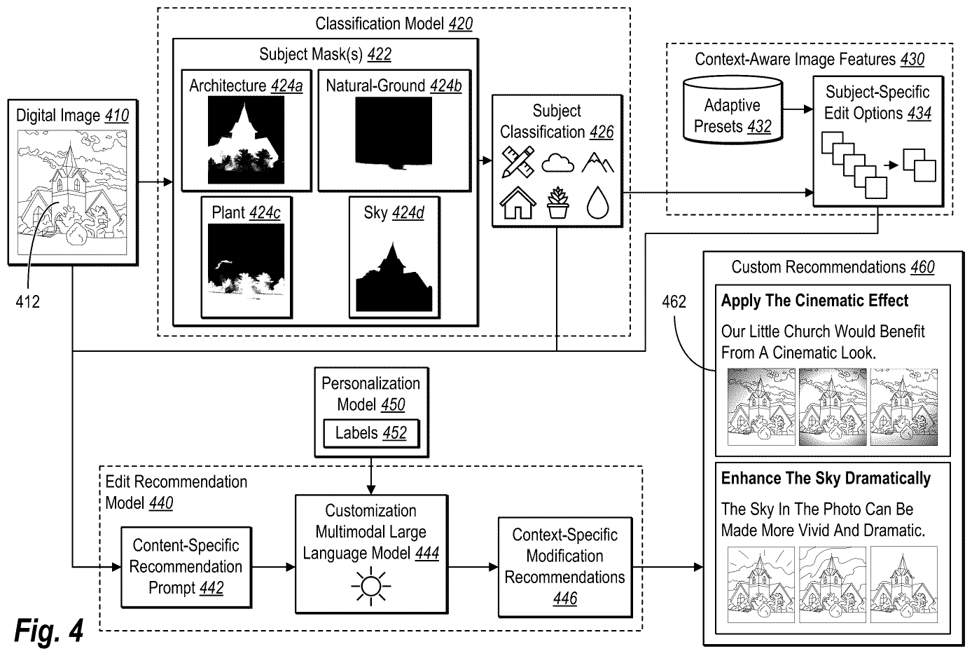

As mentioned, one or more embodiments of the context-aware image refinement system 106 generate custom recommendations for a digital image based on a recommendation classification including a person-specific classification type, a subject-specific classification type, and/or a global classification type. FIG. 4 illustrates an example of the context-aware image refinement system 106 generating custom recommendations for a digital image based on a subject-specific classification type in accordance with one or more embodiments.

As shown in FIG. 4, in certain embodiments, the context-aware image refinement system 106 utilizes a classification model 420 to determine a subject-specific classification type for the recommendation classification based on identifying characteristics for prominent content of a digital image 410. In some cases, the classification model 420 utilizes deep learning-based object recognition (e.g., convolutional neural networks or vision transformers) to analyze contextual relationships and extract distinguishable features of one or more prominent subjects of the digital image 310.

In some cases, the classification model 420 determines the subject classifications 426 by identifying one or more key semantic regions in the digital image 410. For example, the classification model determines the subject classifications 426 such a subject categorization of a subject (e.g., animal or central object), background (e.g., non-primary region providing context), sky (e.g., daytime, cloudy, or night sky elements), architecture (e.g., building, bridge, artificial structure), manmade ground (e.g., roads, tiled floors, artificial landscapes), natural ground (e.g., dirt, sand, grass, rocks), mountain (e.g., large elevated landform), plant (e.g., tree, bush, grass), and/or water (e.g., lake, river, ocean, pool). To illustrate, as shown in FIG. 4, the classification model 420 generates the subject classifications 426 for the digital image 410 utilizing the subject mask(s) 422 to categorize the semantic regions within the digital image 410 as architecture, natural ground, plant, and sky (e.g., from subject mask 424a (architecture), subject mask 424b (natural ground), subject mask 424c (plant), and subject mask 424d (sky)).

In one or more embodiments, the context-aware image refinement system 106 determines context-aware image features 430 for the digital image 410. In some cases, for a recommendation classification corresponding to the subject-specific classification type, the context-aware image refinement system 106 utilizes a set of adaptive presets 432 that includes subject-specific editing parameters such as color grading, contrast, sharpening, or texture editing refinements. To determine the subject-specific edit options 434, embodiments of the context-aware image refinement system 106 select from the set of adaptive presets 432 to map the predefined image editing parameters to the subject classifications 426. For example, the context-aware image refinement system 106 determines the subject-specific edit options 434 as a subset of subject-specific edit options from the set of adaptive presets 432.

As further shown in FIG. 4, embodiments of the context-aware image refinement system 106 utilize an edit recommendation model 440 to generate context-specific modification recommendations 446 for the digital image 410. For example, the context-aware image refinement system 106 generates the context-specific recommendation prompt 442 based on the context-aware image features 430 (e.g., the subject-specific edit options 434). In one or more embodiments, the context-aware image refinement system 106 generates the context-specific recommendation prompt 442 including the subject classifications 426, the digital image 410, the subject-specific edit options 434, and/or an instruction to generate a context-specific modification recommendations 446 that includes a subject-specific modification to the digital image 410. Moreover, based on the context-specific recommendation prompt 442, embodiments of the context-aware image refinement system 106 utilize the customization multimodal large language model 444 to generate the context-specific modification recommendations 446.

As illustrated, in certain embodiments, the context-aware image refinement system 106 utilizes a personalization model 450 to personalize the context-specific modification recommendations 446 and/or the custom recommendations 460. For example, the context-aware image refinement system 106 extracts metadata associated with a user account to determine labels 452 corresponding to one or more subjects in the digital image 410. In some cases, the context-aware image refinement system 106 identifies a subject in the digital image 410, maps the subject to stored profile data (e.g., name, description), and determines the labels 452 corresponding to the subject. To illustrate, the context-aware image refinement system 106 utilizes the personalization model 450 to personalize the context-specific modification recommendations 446 for the digital image 410 and maps user-specific labels to the building 412 of the digital image 410 (as shown by the name “Our Little Church” in the custom recommendation 462).

In one or more embodiments, the context-aware image refinement system 106 generates the custom recommendations 460 for display on a client device. For example, the context-aware image refinement system 106 generates one or more of the custom recommendations 460 based on the context-specific modification recommendations 446. To illustrate, as shown in FIG. 4, the context-aware image refinement system 106 generates a custom recommendation 462 that includes a context-specific modification recommendation tailored to a subject-specific modification for the building 412. As also shown, the context-aware image refinement system 106 generates the custom recommendation 462 including a custom explanation of how and why the digital image 410 could benefit from the custom recommendation 462.

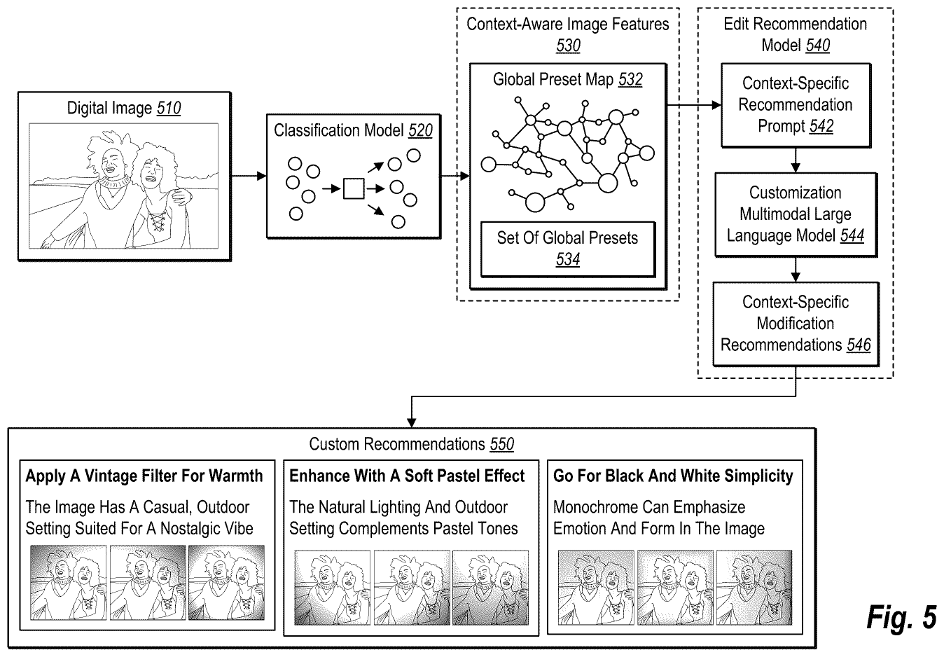

As mentioned, in one or more embodiments, the context-aware image refinement system 106 generates custom recommendations for a digital image based on a recommendation classifications including a person-specific classification type, a subject-specific classification type, and/or a global classification type. FIG. 5 illustrates an example of the context-aware image refinement system 106 generating custom recommendations for a digital image based on a global classification type in accordance with one or more embodiments.

As mentioned, in certain embodiments, the context-aware image refinement system 106 utilizes a classification model 520 to determine a global classification type for the recommendation classification. For example, the context-aware image refinement system 106 selects a global classification type based on identifying the content in a digital image 510 would benefit from a holistic content adjustment or a modification to the global image appearance. In some cases, the context-aware image refinement system 106 determines a global classification type for the recommendation classification based on determining the digital image 510 lacks a clearly distinguishable primary object (e.g., an image with uniformly distributed elements). In some cases, the context-aware image refinement system 106 determines a global classification type for the recommendation classification to provide context-specific modification recommendations 546 for the entire content of the digital image 510 (e.g., to provide global recommendations for an image with distinguishable primary objects).

As mentioned, embodiments of the context-aware image refinement system 106 utilize context-aware image features 530 to generate the custom recommendations 550. In some cases, for a recommendation classification corresponding to the global classification type, the context-aware image refinement system 106 utilizes a global preset map 532 to determine one or more of the context-aware image features 530. For example, the context-aware image refinement system 106 utilizes the global preset map 532 to establish an association between global image styles and image content categories that apply universally across images (rather than being localized to specific image elements). In some cases, the context-aware image refinement system 106 determines a set of global presets 534 representing an association between a plurality of global image styles and a plurality of image content categories utilizing the global preset map 532.

To illustrate, in one or more embodiments, the global preset map 532 includes global image styles such as “Gritty Urban,” “Retro,” “Night,” Monochrome,” and “Cinematic” and image content categories such as “Portraits,” “Urban Scenes,” “Architecture,” and “Astrophotography.” In one or more embodiments, the context-aware image refinement system 106 utilizes a global preset map 532 such as the following Json snippet style definition:
{\n″+
   \“name\”: \“Gritty Urban\”, \n″+
   \“best_suited_for\”: \“street photography, urban scenes, architectural photography\”, \n″+
}, \n″+
{\n″+
   \“name”: \“Retro\”, \n″+
   \“best_suited_for”: \“portraits, fashion photography, vintage-style photos\”, \n″+
}, \n″+
{\n″+
   \“name\”: \“Night\”, \n″+
   \“best_suited_for\”: \“cityscapes, astrophotography\”, \n″+
}, \n″+

As further illustrated in FIG. 5, embodiments of the context-aware image refinement system 106 utilize an edit recommendation model 540 to generate context-specific modification recommendations 546 for the digital image 510. For example, the context-aware image refinement system 106 generates the context-specific recommendation prompt 542 based on the context-aware image features 530 (e.g., the set of global presets 534). In one or more embodiments, the context-aware image refinement system 106 generates the context-specific recommendation prompt 542 including the digital image 510, the set of global presets 534, and an instruction to generate a context-specific modification recommendations 546 that includes a global-specific modification to the digital image 510. Moreover, embodiments of the context-aware image refinement system 106 utilize the context-specific recommendation prompt 542 to prompt the customization multimodal large language model 544 to generate the context-specific modification recommendation 546.

In one or more embodiments, the context-aware image refinement system 106 generates custom recommendations 550 for display on a client device. For example, the context-aware image refinement system 106 generates the custom recommendations 550 based on the context-specific modification recommendations 546. To illustrate, as shown in FIG. 5, the context-aware image refinement system 106 generates a custom recommendations 550 that includes a context-specific modification recommendation tailored to a global enhancement for the digital image 510. As also shown, the context-aware image refinement system 106 generates the custom recommendations 550 that includes a generating a custom recommendation explaining how and why the digital image 510 could benefit from the context-specific modification recommendations 546.

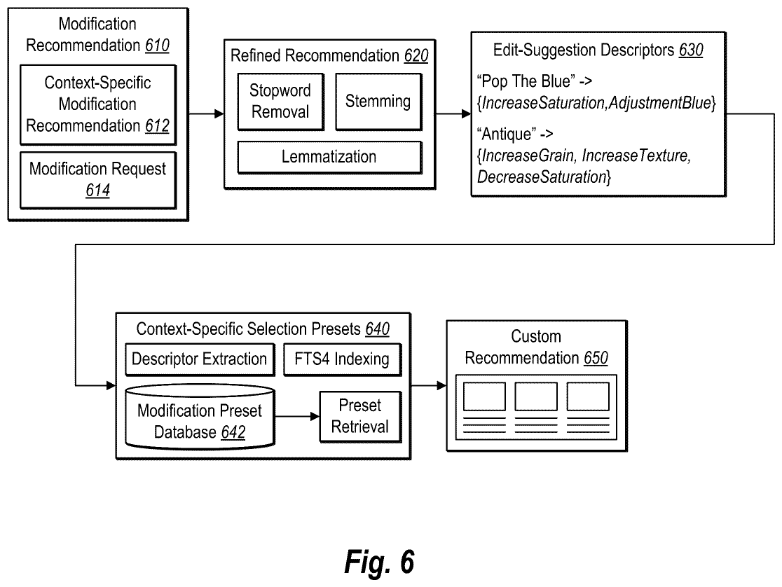

As described in relation to FIGS. 1-5, the context-aware image refinement system 106 generates a custom recommendation for a digital image based on a context-specific modification recommendation. FIG. 6 illustrates an example of the context-aware image refinement system 106 generating a custom recommendation for a digital image from a context-specific modification request and/or a modification request in accordance with one or more embodiments.

As illustrated in FIG. 6, in one or more embodiments, the context-aware image refinement system 106 generates a modification recommendation 610 corresponding to a context-specific modification recommendation 612 or a modification request 614. For example, the context-aware image refinement system 106 generates a context-specific modification recommendation 612 for a digital image based on a recommendation classification such as a person-specific classification type, a subject-specific classification type, and/or a global classification type for the modification recommendation 610. In some cases, the context-aware image refinement system 106 receives and/or generates a modification request 614 corresponding to an image modification intent or image modification query (e.g., a user device search query) for the modification recommendation 610. Based on the modification recommendation 610, embodiments of the context-aware image refinement system 106 generate the custom recommendation 650.

In one or more embodiments, the context-aware image refinement system 106 generates a refined modification recommendation 620 utilizing the modification recommendation 610. For example, the context-aware image refinement system 106 generates the refined modification recommendation 620 by standardizing and/or optimizing the modification recommendation 610 utilizing natural language pre-processing. In some cases, the context-aware image refinement system 106 performs stopword removal to eliminate irrelevant words (e.g., the, a, to) and focus on meaningful terms in the modification recommendation 610. In some cases, the context-aware image refinement system 106 performs stemming to reduce words of the modification recommendation 610 to their root form (e.g., popping->pop). In some cases, the context-aware image refinement system 106 performs lemmatization to convert words of the modification recommendation 610 to their base dictionary form (e.g., adjusting->adjust). In one or more embodiments, the context-aware image refinement system 106 generates the refined modification recommendation 620 as a set of refined style tokens representing a determined intent of the modification recommendation 610.

As further illustrated in FIG. 6, embodiments of the context-aware image refinement system 106 determine edit-suggestion descriptors 630 that correspond to the modification recommendation 610 (e.g., the context-specific modification recommendation 612 and/or modification request 614) from the refined modification recommendation 620. For example, the context-aware image refinement system 106 converts the refined modification recommendation 620 into actionable metadata by mapping the refined modification recommendation 620 to the edit-suggestion descriptors 630. In one or more embodiments, the edit-suggestion descriptors 630 define specific editing actions corresponding to an assessed editing intent. In certain embodiments, the context-aware image refinement system 106 utilizes a lookup table that associates phrases with image adjustments to map the refined modification recommendation 620 to the edit-suggestion descriptors 630. As shown in FIG. 6, in one or more embodiments, the context-aware image refinement system 106 utilizes a mapping such as:
pop the blue→{IncreaseSaturation, AdjustmentBlue}
antique→{IncreaseGrain, IncreaseTexture, DecreaseSaturation}

In certain embodiments, the context-aware image refinement system 106 selects context-specific selection presets 640 that correspond to the modification recommendation 610 based on the edit-suggestion descriptors 630. In some cases, the context-aware image refinement system 106 selects the context-specific selection presets 640 by comparing the edit-suggestion descriptors 630 to the modification presets in the modification preset database 642. For example, the context-aware image refinement system 106 stores and indexes modification presets in a modification preset database 642 for fast preset retrieval and/or matching. In some cases, the context-aware image refinement system 106 retrieves the context-specific selection presets 640 from the modification preset database 642 utilizing FTS4 indexing (Full-Text Search 4). Utilizing FTS4 indexing, embodiments of the context-aware image refinement system 106 use text-based indexing to retrieve the context-specific selection presets 640 in milliseconds, rather than scanning the entire modification preset database 642.

As further shown in FIG. 6, embodiments of the context-aware image refinement system 106 provide the custom recommendation 650 to a client device using the context-specific selection presets 640. For example, the context-aware image refinement system 106 generates the custom recommendation 650 from the context-specific selection presets 640 for display via a graphical user interface of the client device. In some cases, the context-aware image refinement system 106 provides the custom recommendation 650 including an image modification suggestion and a custom recommendation explaining how and why the digital image could benefit from the image modification suggestion. In some cases, the context-aware image refinement system 106 applies all or a portion of the custom recommendation 650 (based on the context-specific selection presets 640) to the digital image for display on the client device. For example, the context-aware image refinement system 106 provides an image modification suggestion to the client device that includes a modification to the digital image for display on the client device based on the custom recommendation 650.

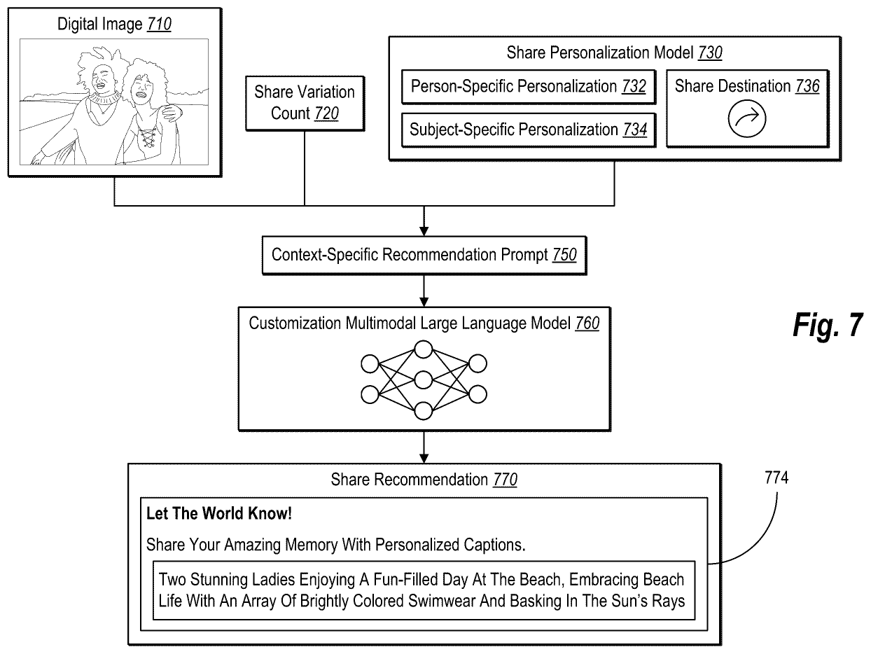

As mentioned, in one or more embodiments, the context-aware image refinement system 106 generates share recommendations for a digital image with a customized caption tailored for a predicted share destination. FIG. 7 illustrates an example of the context-aware image refinement system 106 generating a share recommendation for a digital image in accordance with one or more embodiments.

As shown in FIG. 7, in one or more embodiments, the context-aware image refinement system 106 generates a share recommendation 770 for the digital image 710. For example, the context-aware image refinement system 106 generates the share recommendation 770 by generating customized content for a share caption 774 for the digital image 710 that includes message content based on the distinguishable features displayed in the digital image. Furthermore, the context-aware image refinement system 106 generates the share caption 774 with message content that aligns with an engagement style for a share destination 736. In some cases, the context-aware image refinement system 106 utilizes a share variation count 720, and a share personalization model 730 to generate the share recommendation 770.

As shown, embodiments of the context-aware image refinement system 106 determine the share variation count 720. For example, the context-aware image refinement system 106 determines a number of variations of the share caption 774 to generate for the share recommendation 770 as the share variation count 720. In some cases, the context-aware image refinement system 106 determines the share variation count 720 based on the share destination 736 (e.g., providing more share caption options for certain share destinations than other share destinations). In some cases, the context-aware image refinement system 106 determines the share variation count 720 based on a system configuration.

In one or more embodiments, the context-aware image refinement system 106 utilizes the share personalization model 730 to customize the share recommendation 770. For example, the context-aware image refinement system 106 utilizes the share personalization model 730 to personalize the share caption 774 using a person-specific personalization 732 to map person-specific labels to the content of the digital image 710. In some cases, the context-aware image refinement system 106 utilizes metadata associated with a user account to extract a label corresponding to distinguishable features in the digital image 710. For example, the context-aware image refinement system 106 identifies an individual in the digital image 710, maps the individual to stored profile data (e.g., name, description), and determines the person-specific personalization 732. In one or more embodiments, the context-aware image refinement system 106 incorporates the person-specific personalization into the context-specific recommendation prompt 750 and/or the share recommendation 770.

Relatedly, in some embodiments, the context-aware image refinement system 106 the context-aware image refinement system 106 utilizes the share personalization model 730 to personalize the share caption 774 using a subject-specific personalization 734 to map subject-specific labels to the content of the digital image 710. For example, the context-aware image refinement system 106 identifies a subject in the digital image 710, maps the subject to stored profile data (e.g., name, description), and determines the subject-specific personalization 734. In one or more embodiments, the context-aware image refinement system 106 incorporates the subject-specific personalization into the context-specific recommendation prompt 750 and/or the share recommendation 770.

As also shown in FIG. 7, one or more embodiments of the context-aware image refinement system 106 utilize the share personalization model 730 to determine a share destination 736. For example, the share personalization model 730 analyzes historical sharing patterns of a user account to predict the likely share destination for a given image. In some cases, the context-aware image refinement system 106 tracks previous sharing behaviors and identifies patterns in historical sharing platform selection (e.g., platform1 for personal images, platform2 for professional images). In some cases, the context-aware image refinement system 106 utilizes metadata from historical shared posts (e.g., image type, captions, engagement metrics) to refine the predictions for the share destination 736. In one or more embodiments, the context-aware image refinement system 106 utilizes a machine learning model to predict the most likely share platform based on an analysis of image content type (e.g., portrait, cityscape, event), posting habits (e.g., platform used for similar images), post time (e.g., work hours, weekend activity), and/or other variables.

In certain embodiments, the context-aware image refinement system 106 generates a context-specific recommendation prompt 750 based on the digital image 710, the share variation count 720, the person-specific personalization 732, the subject-specific personalization 734, and/or the share destination 736. To illustrate, the context-aware image refinement system 106 generates the context-specific recommendation prompt 750 including the digital image 710, the share variation count 720, the share destination 736, and an instruction to generate the share recommendation 770 that includes a specified number (e.g. based on the share variation count 720) of share caption options for sharing the digital image 310 to the share destination 736.

Furthermore, embodiments of the context-aware image refinement system 106 prompt the customization multimodal large language model 760 to generate the share recommendation 770 using the context-specific recommendation prompt 750. Based on the context-specific recommendation prompt 750, the customization multimodal large language model 760 generates the share recommendation 770 including a share caption 774 for sharing the digital image 710 such as a customized message based on the distinguishable features displayed in the digital image 710. To illustrate, the customization multimodal large language model 760 generates one or more alternatives for the share recommendation 770, such as the following:
Share Destination 1: Two stunning ladies enjoying a fun-filled day at the beach, embracing beach life with an array of brightly colored swimwear and basking in the sun's rays.
Share Destination 2: Emily & Beth soaking up the sun and beach vibes! Nothing beats a fun-filled day by the ocean, rocking vibrant swimwear and embracing that summer glow! #BeachBabes #SunKissed #Ocean Vibes
Share Destination 3: A picture-perfect day at the beach with these two stunners! Emily & Beth are embracing the ocean breeze, bright swimwear, and pure summer joy. Who else loves a beach getaway? Drop your favorite beach spot in the comments!

Notably, embodiments of the customization multimodal large language model 760 generate the share recommendation 770 with a semantic structure that captures the tone, format, and style of the share destination 736. Furthermore, embodiments of the customization multimodal large language model 760 generate the share recommendation 770 based on requirements for the share destination 736 (e.g., word count, hashtags, titles).

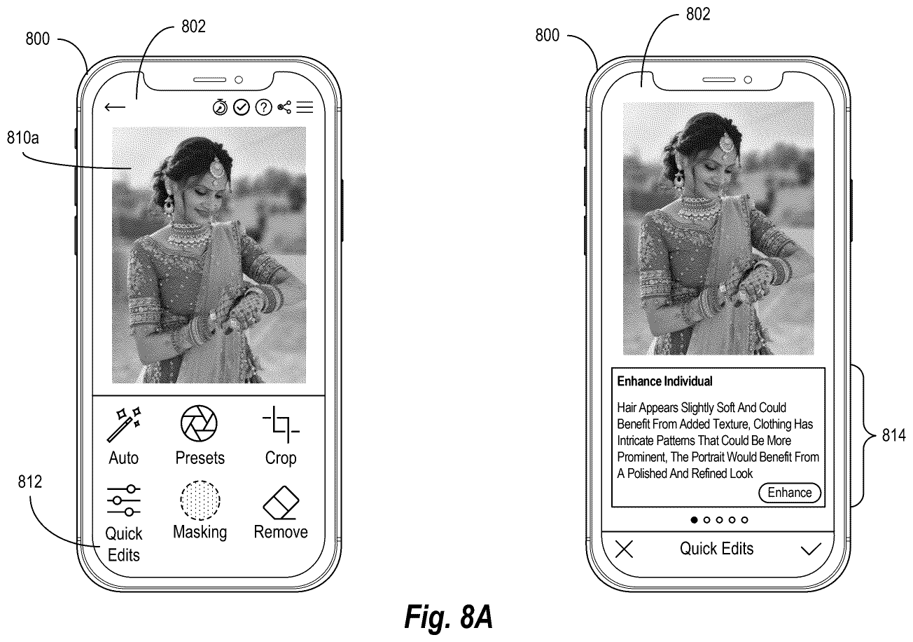

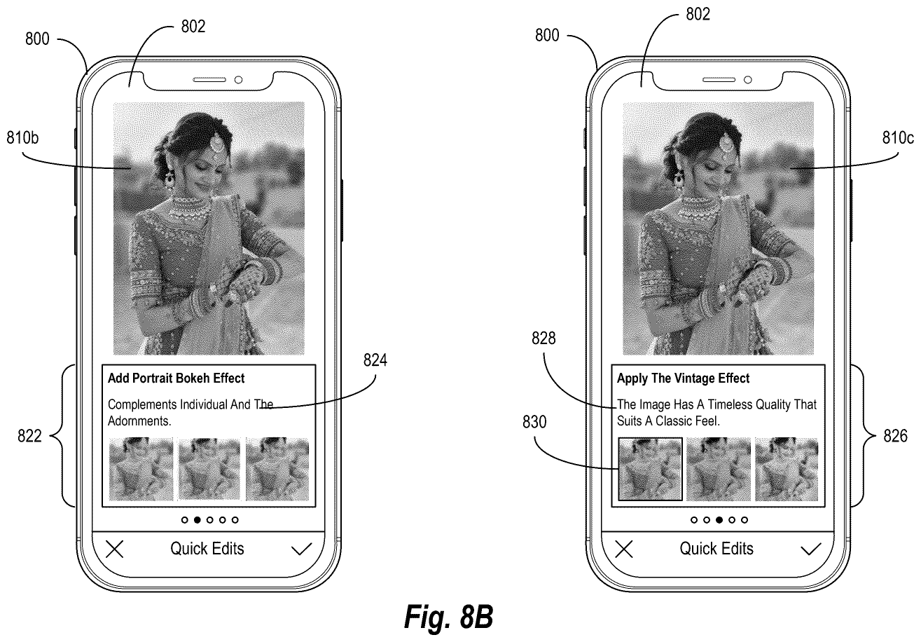

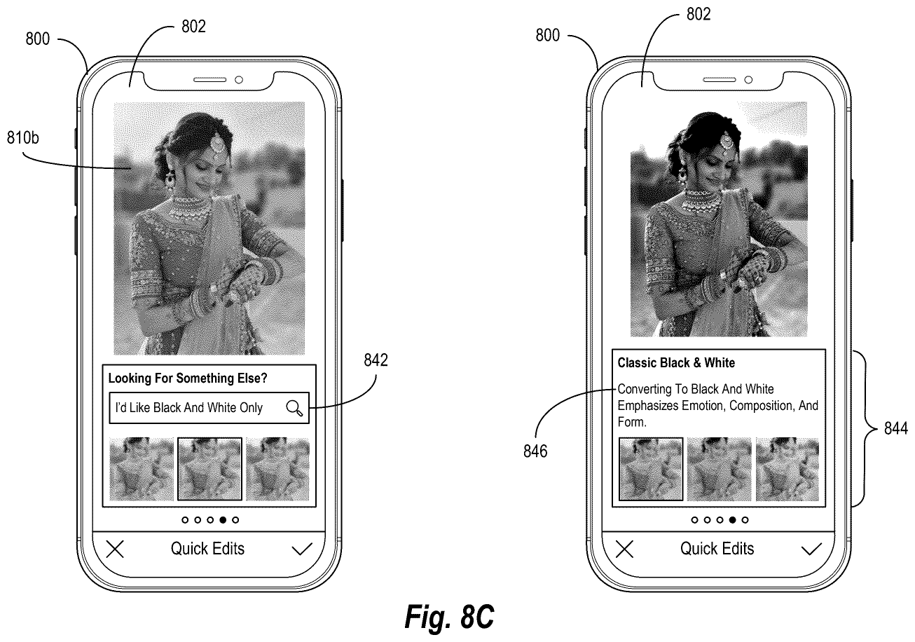

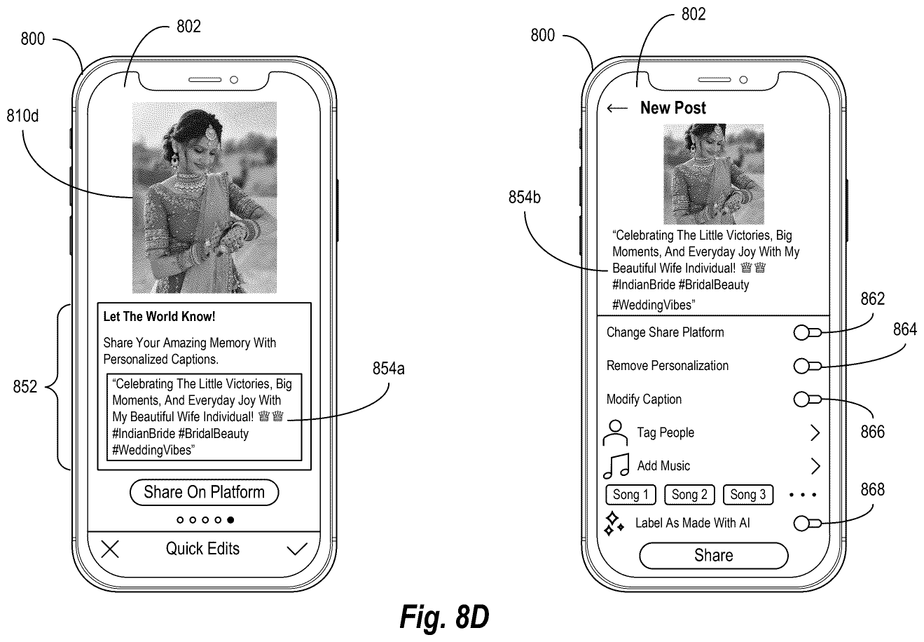

As mentioned, in one or more embodiments, the context-aware image refinement system 106 provides customized contextual digital image edit recommendations for display on a graphical user interface of a client device. FIGS. 8A-8D illustrate an example of the context-aware image refinement system providing custom recommendations for display on a graphical user interface in accordance with one or more embodiments.

As illustrated in FIG. 8A, the context-aware image refinement system 106 provides customized contextual digital image edit recommendations (e.g., custom recommendations, context-specific modification recommendations, share recommendations) to a client device 800 via a graphical user interface 802. In particular, the context-aware image refinement system 106 provides customized contextual digital image edit recommendations directed to enhancements or adjustments of a digital image 810a that are tailored to the context and content of the digital image 810a. In one or more embodiments, the context-aware image refinement system 106 presents the customized contextual digital image edit recommendations via the graphical user interface 802 as compact, concise, and non-intrusive recommendations designed to accommodate the small size of a mobile device screen (e.g., as small cards or bottom-sheet overlays). As shown, in one or more embodiments, the context-aware image refinement system 106 provides an option 812 to display the customized contextual digital image edit recommendations via an application on the client device 800.

In one or more embodiments, based on a user device selection of the option 812, the context-aware image refinement system 106 provides a custom recommendation 814 to “Enhance Manu” for display on the graphical user interface 802. As shown, in some cases, the context-aware image refinement system 106 includes a description of how and why the digital image 810a could benefit from one or more edit modifications. For example, the context-aware image refinement system 106 provides the custom recommendation 814 including a person-specific modification suggestion of “Hair appears slightly soft and could benefit from added texture” in combination with a global modification suggestion of “The portrait would benefit from a polished and refined look.” As also shown, the context-aware image refinement system 106 provides the custom recommendation 814 including a personalization in the form of the name “Aditi.”

As shown in FIG. 8B, embodiments of the context-aware image refinement system 106 provides additional custom recommendations for display on the graphical user interface 802. In some cases, the context-aware image refinement system 106 provides a custom recommendation 822 based on a person-specific classification type. For example, the context-aware image refinement system 106 provides the custom recommendation 822 to “Add Portrait Bokeh effect” to selectively blur the background and keep the person in focus. As also shown, the context-aware image refinement system 106 provides an explanation 824 of how and why the custom recommendation 822 benefits the digital image 810b. Furthermore, the context-aware image refinement system 106 provides a personalized recommendation for the custom recommendation 822 as illustrated by the inclusion of the name “Aditi” in the explanation 824. Notably, in one or more embodiments, the context-aware image refinement system 106 generates the custom recommendation 822 as a concise recommendation (e.g., a small number of contextually appropriate suggestions) targeted to streamline the workflow on the mobile device.

As also illustrated, embodiments of the context-aware image refinement system 106 provide a custom recommendation 826 based on a global classification type. For example, the context-aware image refinement system 106 provides the custom recommendation 826 to “Apply the Vintage effect” to apply a universal aesthetic adjustment to the entire content of the digital image 810c. As also shown, the context-aware image refinement system 106 provides an explanation 828 of how and why the custom recommendation 826 benefits the digital image 810c. As illustrated, the context-aware image refinement system 106 provides small preview images displaying how the custom recommendation 826 affects the digital image 810a via a selection of thumbnail images. For example, the context-aware image refinement system 106 displays the selection of thumbnail images with varied adjustment levels for color, saturation, and grain to implement a vintage effect on the content of the digital image 810a. In some cases, the context-aware image refinement system 106 provides a preview implementing the selected thumbnail image 830 as the digital image 810c for display on the graphical user interface 802.

As shown in FIG. 8C, in some embodiments, the context-aware image refinement system 106 generates a custom recommendation 844 based on a modification request 842 generated by the client device 800. For instance, based on the modification request 842 of “I'd like black and white only,” the context-aware image refinement system 106 generates a custom recommendation 844 as described above in relation to FIG. 6. For example, the context-aware image refinement system 106 performs stopword removal, stemming, and lemmatization to generate a set of refined style tokens (e.g., {black, white}). In some cases, the context-aware image refinement system 106 determines edit-suggestion descriptors such as {ConvertToGrayscale, IncreaseContrast, BoostShadows, BoostHighlights} and generates the custom recommendation 844 based on a comparison of the edit-suggestion descriptors with a selection of context-specific selection presets. As shown, the context-aware image refinement system 106 provides the custom recommendation 844 including thumbnail images depicting modifications to the digital image 810a. In one or more embodiments, the context-aware image refinement system 106 generates the custom recommendation 844 to include an explanation 846 describing how and why the digital image 810a could benefit from the custom recommendation 844 for the modification request 842.

As shown in FIG. 8D, embodiments of the context-aware image refinement system 106 provide a share recommendation 852 for the digital image 810d. For example, the context-aware image refinement system 106 generates the share recommendation 852 for the digital image 810d with a share caption 854a tailored for a predicted share destination of “Platform.” As described above, the context-aware image refinement system 106 generates the share recommendation 852 by generating customized content for the share caption 854a for the digital image 810d that aligns with an engagement style for the share platform. In one or more embodiments, the context-aware image refinement system 106 provides a personalized recommendation for the custom recommendation 844 as illustrated by the inclusion of the name “Aditi” in the share caption 854a.

As also shown, certain embodiments of the context-aware image refinement system 106 provide customization options for the share recommendation 852. For example, the context-aware image refinement system 106 provides an option 862 to change the share platform. In one or more embodiments, the context-aware image refinement system 106 modifies the customized caption 854b based on a change to the share platform (e.g., to provide customized content that aligns with an engagement style for the new share destination). As also shown, embodiments of the context-aware image refinement system 106 provide an option 864 to remove personalization from the customized caption 854b (e.g., PII), an option 866 to modify the customized caption 854b, and/or an option 868 to label the post as generated by AI.

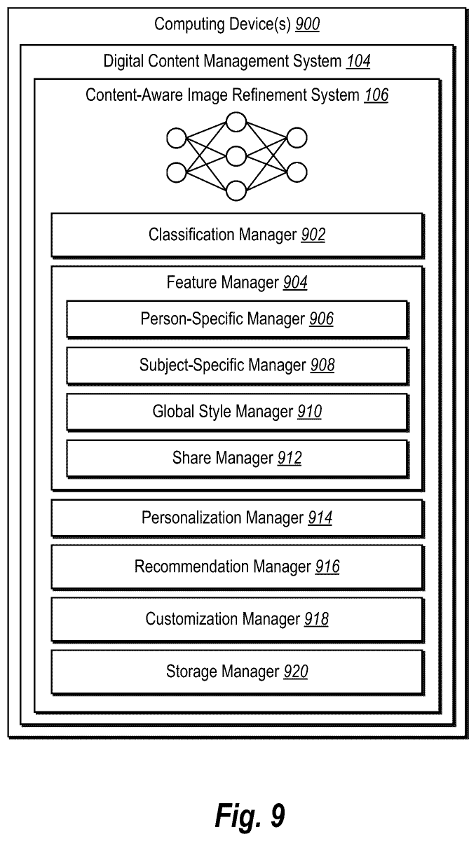

Turning now to FIG. 9, additional detail will now be provided regarding various components and capabilities of the context-aware image refinement system 106. In particular, FIG. 9 illustrates the context-aware image refinement system 106 implemented by the computing device 900 (e.g., the server device(s) 102 and/or one of the client device(s) 110 discussed above with reference to FIG. 1). Additionally, the context-aware image refinement system 106 is also part of the digital content management system 104. As shown in FIG. 9, the context-aware image refinement system 106 includes, but is not limited to, a classification manager 902, a feature manager 904, a personalization manager 914, a recommendation manager 916, a customization manager 918, and a data storage manager 920.

As just mentioned, and as illustrated in FIG. 9, the context-aware image refinement system 106 includes the classification manager 902. In one or more embodiments, the classification manager 902 manages the recommendation classifications for digital images. In some embodiments, the classification manager 902 utilizes one or more deep learning models, such as convolutional neural networks or vision transformers, to segment and classify objects within the digital image. Furthermore, the classification manager 902 analyzes the digital image to identify distinguishable features (e.g., key elements) displayed in the digital image. Utilizing the distinguishable features, the classification manager 902 determines a recommendation classification such as a person-specific classification type, a subject-specific classification type, and/or a global classification type.

As further shown in FIG. 9, the context-aware image refinement system 106 includes the feature manager 904. In one or more embodiments, the feature manager 904 determines context-aware image features based on the recommendation classification from the classification manager 902. In one or more embodiments, the feature manager 904 utilizes a person-specific manager 906, a subject-specific manager 908, a global style manager 910, and/or a share manager 912 to generate and/or determine the context-aware image features.

In one or more embodiments, for the person-specific classification type, the feature manager 904 utilizes the person-specific manager 906 to generate the context-aware image features. For example, the person-specific manager 906 generates context-aware image features including person-specific edit options to generate context-specific modification recommendations for a person in the digital image utilizing the recommendation manager 916. In one or more embodiments, for a person-specific classification type, the person-specific manager 906 generates context-aware image features including a masked image and portrait retouching attributes.

In one or more embodiments, for the subject-specific classification type, the feature manager 904 utilizes the subject-specific manager 908 to generate the context-aware image features. For example, the subject-specific manager 908 generates context-aware image features including subject-specific edit options to generate context-specific modification recommendations for a subject in the digital image utilizing the recommendation manager 916. In one or more embodiments, for a subject-specific classification type, the subject-specific manager 908 generates context-aware image features including subject-specific edit options.

In one or more embodiments, for the global classification type, the feature manager 904 utilizes the global style manager 910 to generate the context-aware image features. For example, the global style manager 910 generates context-aware image features including global-specific edit options to generate context-specific modification recommendations for the entire digital image utilizing the recommendation manager 916. In one or more embodiments, for a global classification type, the global style manager 910 generates context-aware image features including a set of global presets utilizing a global preset map.

In one or more embodiments, the feature manager 904 provides share recommendations for digital images utilizing the share manager 912. For example, the share manager 912 extracts metadata for a user account associated with the digital image to determine a predicted share destination for the digital image based on historical share patterns for the user account. In some cases, for the context-specific modification recommendations, the share manager 912 determines a share destination and an associated share variation count for sharing the digital image.

In one or more embodiments, the context-aware image refinement system 106 personalizes the context-specific modification recommendations utilizing the personalization manager 914. For example, the personalization manager 914 extracts metadata for a user account associated with the digital image to personalize the context-specific modification recommendations specific to the user account. In some cases, the personalization manager 914 determines names for persons displayed in the digital image for the context-specific modification recommendations. In some cases, the personalization manager 914 determines names of places/destinations displayed in the digital image for the context-specific modification recommendations.

As also shown in FIG. 9, the context-aware image refinement system 106 utilizes the recommendation manager 916 to generate one or more of the context-specific modification recommendations for the digital image. For example, the recommendation manager 916 generates context-specific modification recommendations for the digital image based on the recommendation classifications from the classification manager 902, the context-aware image features from the feature manager 904, and the personalization from the personalization manager 914. In one or more embodiments, the recommendation manager 916 utilizes a customization multimodal large language model to generate the context-specific modification recommendations.

In one or more embodiments, the context-aware image refinement system 106 utilizes the customization manager 918 to further refine the context-specific modification recommendations from the recommendation manager 916. In some embodiments, the customization manager 918 generates a refined modification recommendation by standardizing and/or optimizing the context-specific modification recommendations utilizing natural language pre-processing. In some cases, the customization manager 918 converts the refined modification recommendation into actionable preset metadata by mapping the refined modification recommendation to edit-suggestion descriptors which define specific editing actions corresponding to various editing intents. In certain embodiments, the customization manager 918 matches the edit-suggestion descriptors to modification presets in a modification preset database. In some embodiments, the customization manager 918 generates a custom recommendation for the digital image from the context-specific selection presets for display via a graphical user interface of the client device.

Additionally, as shown, the context-aware image refinement system 106 includes the data storage manager 920. In particular, the data storage manager 920 (implemented by one or more memory devices) stores digital images, image masks, context-aware image features, context-specific modification recommendations, and custom recommendations. The data storage manager 920 facilitates the use of digital images by the context-aware image refinement system 106.

Each of the components 900-920 of the context-aware image refinement system 106 includes software, hardware, or both. For example, the components 900-920 include one or more instructions stored on a computer-readable storage medium and executable by processors of one or more computing devices, such as a client device or server device. When executed by the one or more processors, the computer-executable instructions of the context-aware image refinement system 106 causes the computing device(s) to perform the methods described herein. Alternatively, the components 900-920 include hardware, such as a special-purpose processing device to perform a certain function or group of functions. Alternatively, the components 900-920 of the context-aware image refinement system 106 include a combination of computer-executable instructions and hardware.

Furthermore, the components 900-920 of the context-aware image refinement system 106 are implemented as one or more operating systems, as one or more stand-alone applications, as one or more modules of an application, as one or more plug-ins, as one or more library functions or functions called by other applications, and/or as a cloud-computing model. Thus, in some embodiments, the components 900-920 of the context-aware image refinement system 106 are implemented as a stand-alone application, such as a desktop or mobile application. Furthermore, in some embodiments, the components 900-920 of the context-aware image refinement system 106 are implemented as one or more web-based applications hosted on a remote server. Alternatively, or additionally, the components 900-920 of the context-aware image refinement system 106 are implemented in a suite of mobile device applications or “apps.” For example, in one or more embodiments, the context-aware image refinement system 106 comprises or operates in connection with digital software applications such as: ADOBE® PHOTOSHOP®, ADOBE® PHOTOSHOP® LIGHTROOM®, ADOBE® PHOTOSHOP® LIGHTROOM® MOBILE, ADOBE® PHOTOSHOP® ELEMENTS, ADOBE® PHOTOSHOP® EXPRESS, ADOBE® PHOTOSHOP® MOBILE. The foregoing are either registered trademarks or trademarks of Adobe Inc. in the United States and/or other countries.

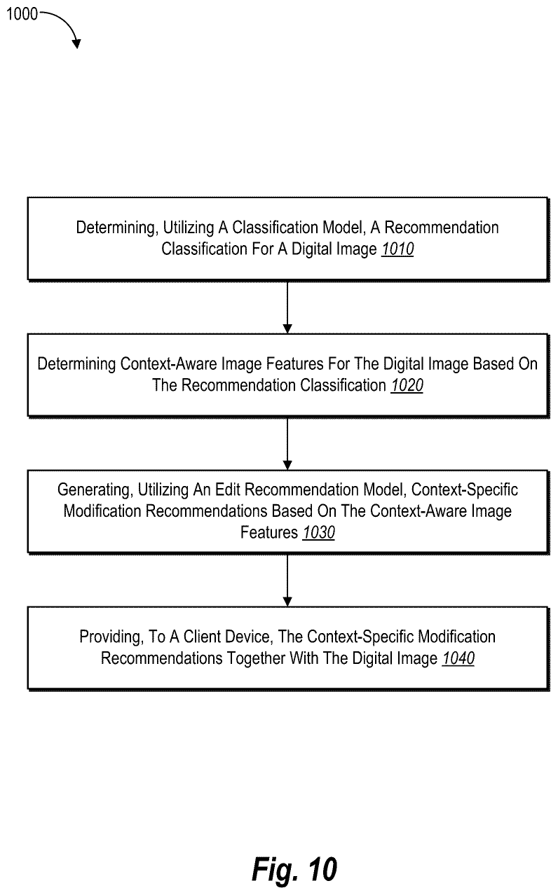

FIGS. 1-9, the corresponding text, and the examples provide a number of different methods, systems, devices, and non-transitory computer-readable media of the context-aware image refinement system 106. In addition to the foregoing, one or more embodiments are also described in terms of flowcharts comprising acts for accomplishing a particular result, as shown in FIG. 10. In some embodiments, the acts shown in FIG. 10 are performed in connection with more or fewer acts. Further, the acts may be performed in differing orders. Additionally, in various embodiments, the acts described herein are repeated or performed in parallel with one another or parallel with different instances of the same or similar acts. A non-transitory computer-readable medium includes instructions that, when executed by one or more processors, cause a computing device to perform the acts of FIG. 10. In some embodiments, a system is configured to perform the acts of FIG. 10. Alternatively, the acts of FIG. 10 are performed as part of a computer-implemented method.

FIG. 10 illustrates a flowchart of a series of acts for generating context-specific recommendations and providing the context-specific recommendations to a client device in accordance with one or more embodiments. While FIG. 10 illustrates acts according to one embodiment, alternative embodiments omit, add to, reorder, and/or modify any acts shown in FIG. 10.

FIG. 10 illustrates an example series of acts 1000 for utilizing a context-aware image refinement system 106 to provide context-specific modification recommendations to a client device. In particular, in certain embodiments, the series of acts 1000 includes an act 1010 of determining, utilizing a classification model, a recommendation classification for a digital image. Specifically, in one or more embodiments, the act 1010 includes determining, utilizing a classification model, a recommendation classification for a digital image by analyzing the digital image to identify one or more distinguishable features displayed in the digital image. In particular, in certain embodiments, the series of acts 1000 includes an act 1020 of determining context-aware image features for the digital image based on the recommendation classification. In particular, in one or more embodiments, the act 1020 includes determining one or more context-aware image features for the digital image based on the recommendation classification. As illustrated, in some embodiments, the series of acts 1000 also includes an act 1030 of generating, utilizing an edit recommendation model, context-specific modification recommendations based on the context-aware image features. In particular, in one or more embodiments, the act 1030 includes generating, utilizing an edit recommendation model, one or more context-specific modification recommendations for the digital image based on the one or more context-aware image features. In one or more embodiments, the series of acts 1000 also includes an act 1040 of providing, to a client device, the context-specific modification recommendations together with the digital image. In particular, in one or more embodiments, the act 1040 includes providing, to a client device, the one or more context-specific modification recommendations together with the digital image.

In addition (or in the alternative) to the acts described above, in certain embodiments, the context-aware image refinement system series of acts 1000 also includes generating a context-specific recommendation prompt comprising the one or more context-aware image features and an instruction to generate one or more context-specific modification recommendations for the digital image based on the one or more context-aware image features. In some embodiments, the series of acts 1000 also includes generating, utilizing a customization multimodal large language model from the context-specific recommendation prompt, the one or more context-specific modification recommendations for the digital image. Moreover, in one or more embodiments, the context-aware image refinement system 106 series of acts 1000 includes an act of generating a custom recommendation explaining how and why the digital image could benefit from an edit modification associated with the one or more context-specific modification recommendations. Further still, in some embodiments, the context-aware image refinement system 106 series of acts 1000 includes providing, for display via the client device, the custom recommendation.

Furthermore, in one or more embodiments, the context-aware image refinement system series of acts 1000 includes determining a person-specific classification type by analyzing the digital image to identify a person displayed in the digital image. Moreover, one or more embodiments, the series of acts 1000 includes selecting the one or more context-aware image features comprising portrait retouching attributes corresponding to image modifications for modifying a physical appearance of the person. Further still, in one or more embodiments, the series of acts 1000 includes determining a subject-specific classification type by extracting, from the digital image, the one or more distinguishable features corresponding to characteristics of a prominent subject.

Moreover, in one or more embodiments, the series of acts 1000 includes determining a subject categorization for the prominent subject. In certain embodiments, the series of acts 1000 further includes selecting, based on the subject categorization, the one or more context-aware image features comprising a subset of subject-specific edit options from a plurality of subject-specific edit options. Moreover, one or more embodiments, the series of acts 1000 includes determining a global classification type for modifying global image appearances. Furthermore, in one or more embodiments, the series of acts 1000 includes selecting the one or more context-aware image features comprising a set of global presets mapping between a plurality of global image styles and a plurality of image content categories.

Moreover, in one or more embodiments, the series of acts 1000 includes generating one or more edit-suggestion descriptors corresponding to the one or more context-specific modification recommendations. In one or more embodiments, the series of acts 1000 includes generating a custom recommendation based on a comparison of the one or more edit-suggestion descriptors with a plurality of context-specific selection presets. Further still, in one or more embodiments, the series of acts 1000 includes providing, for display via the client device, the custom recommendation. In one or more embodiments, the series of acts 1000 further includes determining, based on historical patterns of digital image sharing for the client device, a share destination. In addition, in one or more embodiments, the series of acts 1000 includes generating a customized caption for sharing the digital image comprising a message based on the one or more distinguishable features displayed in the digital image and with a semantic structure based on the share destination. Furthermore, in one or more embodiments, the series of acts 1000 includes providing, for display on the client device, the customized caption.

In addition, in one or more embodiments, the series of acts 1000 includes determining, utilizing a classification model, a recommendation classification for a digital image by analyzing the digital image to identify one or more distinguishable features displayed in the digital image. Moreover, in one or more embodiments, the series of acts 1000 includes determining context-aware image features for the digital image based on the recommendation classification. In one or more embodiments, the series of acts 1000 includes generating a context-specific recommendation prompt comprising the context-aware image features and an instruction to generate a context-specific modification recommendation for the digital image based on the context-aware image features. Furthermore, in one or more embodiments, the series of acts 1000 includes generating, utilizing a customization multimodal large language model from the context-specific recommendation prompt, the context-specific modification recommendation for the digital image.

In some embodiments, the series of acts 1000 also includes determining a person-specific classification type by analyzing the digital image to identify a person displayed in the digital image. Moreover, in one or more embodiments, the context-aware image refinement system 106 series of acts 1000 includes extracting an object mask of the person from the digital image. Further still, in some embodiments, the context-aware image refinement system 106 series of acts 1000 includes determining a subject-specific classification type by extracting, from the digital image, the one or more distinguishable features corresponding to characteristics of a prominent subject. Furthermore, in one or more embodiments, the context-aware image refinement system series of acts 1000 determining a subset of subject-specific edit options from a plurality of subject-specific edit options.

Further still, in one or more embodiments, the series of acts 1000 includes determining a set of global presets defining an association between a plurality of global image styles and a plurality of image content categories. Moreover, in one or more embodiments, the series of acts 1000 includes generating the context-specific recommendation prompt comprising the set of global presets. In certain embodiments, the series of acts 1000 further includes extracting, via metadata associated with a user account for the digital image, a label for the one or more distinguishable features displayed in the digital image. Moreover, one or more embodiments, the series of acts 1000 includes generating, for display on a client device, a custom recommendation comprising the label utilizing the context-specific modification recommendation.

Moreover, one or more embodiments, the series of acts 1000 includes determining, based on historical patterns of digital image sharing for a client device, a share destination. Furthermore, in one or more embodiments, the series of acts 1000 includes generating a customized caption for sharing the digital image comprising a message based on the one or more distinguishable features displayed in the digital image and with a semantic structure based on the share destination. Moreover, in one or more embodiments, the series of acts 1000 includes providing, for display on a client device, the customized caption together with a selection of the share destination.

In one or more embodiments, the series of acts 1000 includes determining, utilizing a classification model, a person-specific classification type for a digital image by analyzing the digital image to identify a person displayed in the digital image. Further still, in one or more embodiments, the series of acts 1000 includes generating, utilizing an object mask, a masked image comprising the person. In one or more embodiments, the series of acts 1000 further includes generating a context-specific recommendation prompt comprising the masked image, portrait retouching attributes, and an instruction to generate a context-specific modification recommendation comprising a person-specific modification to the digital image. In addition, in one or more embodiments, the series of acts 1000 includes generating, utilizing a customization multimodal large language model from the context-specific recommendation prompt, the context-specific modification recommendation comprising the person-specific modification to the digital image.

Furthermore, in one or more embodiments, the series of acts 1000 includes extracting, via metadata associated with a user account for the digital image, a name associated with the person displayed in the digital image. Further still, in one or more embodiments, the series of acts 1000 includes generating, for display on a client device, a custom recommendation comprising the name utilizing the context-specific modification recommendation. Moreover, in one or more embodiments, the series of acts 1000 includes determining, based on historical patterns of digital image sharing for the client device, a share destination. In certain embodiments, the series of acts 1000 further includes generating a customized caption describing content of the digital image that incorporates the name and utilizes a semantic structure based on the share destination. Moreover, one or more embodiments, the series of acts 1000 includes providing, for display on a client device, the customized caption together with a selection of the share destination.

Moreover, one or more embodiments, the series of acts 1000 includes generating, utilizing an object mask, an additional masked image comprising an additional person displayed in the digital image. Furthermore, in one or more embodiments, the series of acts 1000 includes generating, utilizing the customization multimodal large language model, an additional customized recommendation comprising an additional person-specific modification to the digital image based on the portrait retouching attributes and the additional masked image. Moreover, in one or more embodiments, the series of acts 1000 includes determining a set of global presets defining an association between a plurality of global image styles and a plurality of image content categories. Additionally, in one or more embodiments, the series of acts 1000 includes generating, utilizing the customization multimodal large language model, an additional customized recommendation comprising a global style modification to the digital image based on the digital image and the set of global presets.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 11 illustrates a block diagram of an example computing device 1100 that may be configured to perform one or more of the processes described above. One will appreciate that one or more computing devices, such as the computing device 1100 may represent the computing devices described above (e.g., server device(s) 102, client device(s) 110, and computing device 1100). In one or more embodiments, the computing device 1100 may be a mobile device (e.g., a mobile telephone, a smartphone, a PDA, a tablet, a laptop, a camera, a tracker, a watch, a wearable device, etc.). In some embodiments, the computing device 1100 may be a non-mobile device (e.g., a desktop computer or another type of client device). Further, the computing device 1100 may be a server device that includes cloud-based processing and storage capabilities.

As shown in FIG. 1, the computing device 1100 can include one or more processor(s) 1102, memory 1104, a storage device 1106, I/O interfaces 1108 (or “input/output interfaces”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular embodiment.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
determining, utilizing a classification model, a recommendation classification for a digital image by analyzing the digital image to identify one or more distinguishable features displayed in the digital image;
determining one or more context-aware image features for the digital image based on the recommendation classification;
generating, utilizing an edit recommendation model, one or more context-specific modification recommendations for the digital image based on the one or more context-aware image features; and
providing, to a client device, the one or more context-specific modification recommendations together with the digital image.

2. The computer-implemented method of claim 1, further comprising:
generating a context-specific recommendation prompt comprising the one or more context-aware image features and an instruction to generate one or more context-specific modification recommendations for the digital image based on the one or more context-aware image features; and
wherein generating the one or more context-specific modification recommendations further comprises generating, utilizing a customization multimodal large language model from the context-specific recommendation prompt, the one or more context-specific modification recommendations for the digital image.

3. The computer-implemented method of claim 1, further comprising:
generating a custom recommendation explaining how and why the digital image could benefit from an edit modification associated with the one or more context-specific modification recommendations; and
providing, for display via the client device, the custom recommendation.

4. The computer-implemented method of claim 1, wherein:
determining the recommendation classification further comprises determining a person-specific classification type by analyzing the digital image to identify a person displayed in the digital image; and
determining the one or more context-aware image features further comprises selecting the one or more context-aware image features comprising portrait retouching attributes corresponding to image modifications for modifying a physical appearance of the person.

5. The computer-implemented method of claim 1, wherein determining the recommendation classification further comprises determining a subject-specific classification type by extracting, from the digital image, the one or more distinguishable features corresponding to characteristics of a prominent subject.

6. The computer-implemented method of claim 5, wherein determining the one or more context-aware image features further comprises:
determining a subject categorization for the prominent subject; and
selecting, based on the subject categorization, the one or more context-aware image features comprising a subset of subject-specific edit options from a plurality of subject-specific edit options.

7. The computer-implemented method of claim 1, wherein:
determining the recommendation classification further comprises a global classification type for modifying global image appearances; and
determining the one or more context-aware image features further comprises selecting the one or more context-aware image features comprising a set of global presets mapping between a plurality of global image styles and a plurality of image content categories.

8. The computer-implemented method of claim 1, further comprising:
generating one or more edit-suggestion descriptors corresponding to the one or more context-specific modification recommendations;
generating a custom recommendation based on a comparison of the one or more edit-suggestion descriptors with a plurality of context-specific selection presets; and
providing, for display via the client device, the custom recommendation.

9. The computer-implemented method of claim 1, further comprising:
determining, based on historical patterns of digital image sharing for the client device, a share destination;
generating a customized caption for sharing the digital image comprising a message based on the one or more distinguishable features displayed in the digital image and with a semantic structure based on the share destination; and
providing, for display on the client device, the customized caption.

10. A system comprising:
one or more memory devices; and
one or more processors coupled to the one or more memory devices that cause the system to perform operations comprising:
determining, utilizing a classification model, a recommendation classification for a digital image by analyzing the digital image to identify one or more distinguishable features displayed in the digital image;
determining context-aware image features for the digital image based on the recommendation classification;
generating a context-specific recommendation prompt comprising the context-aware image features and an instruction to generate a context-specific modification recommendation for the digital image based on the context-aware image features; and
generating, utilizing a customization multimodal large language model from the context-specific recommendation prompt, the context-specific modification recommendation for the digital image.

11. The system of claim 10, wherein:
determining the recommendation classification further comprises determining a person-specific classification type by analyzing the digital image to identify a person displayed in the digital image; and
determining the context-aware image features further comprises extracting an object mask of the person from the digital image.

12. The system of claim 10, wherein:
determining the recommendation classification further comprises determining a subject-specific classification type by extracting, from the digital image, the one or more distinguishable features corresponding to characteristics of a prominent subject; and
determining the context-aware image features further comprises determining a subset of subject-specific edit options from a plurality of subject-specific edit options.

13. The system of claim 10, further comprising:
determining a set of global presets defining an association between a plurality of global image styles and a plurality of image content categories; and
generating the context-specific recommendation prompt comprising the set of global presets.

14. The system of claim 10, further comprising:
extracting, via metadata associated with a user account for the digital image, a label for the one or more distinguishable features displayed in the digital image; and
generating, for display on a client device, a custom recommendation comprising the label utilizing the context-specific modification recommendation.

15. The system of claim 10, further comprising:
determining, based on historical patterns of digital image sharing for a client device, a share destination;
generating a customized caption for sharing the digital image comprising a message based on the one or more distinguishable features displayed in the digital image and with a semantic structure based on the share destination; and
providing, for display on a client device, the customized caption together with a selection of the share destination.

16. A non-transitory computer-readable medium storing instructions thereon that, when executed by at least one processor, cause the at least one processor to perform operations comprising:
determining, utilizing a classification model, a person-specific classification type for a digital image by analyzing the digital image to identify a person displayed in the digital image;
generating, utilizing an object mask, a masked image comprising the person;
generating a context-specific recommendation prompt comprising the masked image, portrait retouching attributes, and an instruction to generate a context-specific modification recommendation comprising a person-specific modification to the digital image; and
generating, utilizing a customization multimodal large language model from the context-specific recommendation prompt, the context-specific modification recommendation comprising the person-specific modification to the digital image.

17. The non-transitory computer-readable medium of claim 16, further comprising:
extracting, via metadata associated with a user account for the digital image, a name associated with the person displayed in the digital image; and
generating, for display on a client device, a custom recommendation comprising the name utilizing the context-specific modification recommendation.

18. The non-transitory computer-readable medium of claim 17, further comprising:
determining, based on historical patterns of digital image sharing for the client device, a share destination;
generating a customized caption describing content of the digital image that incorporates the name and utilizes a semantic structure based on the share destination; and
providing, for display on a client device, the customized caption together with a selection of the share destination.

19. The non-transitory computer-readable medium of claim 16, further comprising:
generating, utilizing an object mask, an additional masked image comprising an additional person displayed in the digital image; and
generating, utilizing the customization multimodal large language model, an additional customized recommendation comprising an additional person-specific modification to the digital image based on portrait retouching attributes and the additional masked image.

20. The non-transitory computer-readable medium of claim 16, further comprising:
determining a set of global presets defining an association between a plurality of global image styles and a plurality of image content categories; and
generating, utilizing the customization multimodal large language model, an additional customized recommendation comprising a global style modification to the digital image based on the digital image and the set of global presets.
